(19) United States
(12) Patent Application Publication
(10) Pub. No.: US 2014/0279692 A1
(43) Pub. Date: Sep. 18, 2014

(54) OPTIMIZING RETURN ON INVESTMENT IN REAL PROPERTY

(71) Applicants: Brad A. Boothby, San Diego, CA (US); Byron L. Hanchett, Rancho Santa Fe, CA (US)

(72) Inventors: Brad A. Boothby, San Diego, CA (US); Byron L. Hanchett, Rancho Santa Fe, CA (US)

(21) Appl. No.: 14/202,022

(22) Filed: Mar. 10, 2014

Related U.S. Application Data
(60) Provisional application No. 61/777,134, filed on Mar. 12, 2013.

(51) Int. Cl. G06Q 40/06

(52) U.S. Cl. CPC G06Q 40/06
USPC 705/36 R

(57) ABSTRACT

The present invention is directed to a system and method comprising an expert system that provides a logical step by step decision making support system that assists and guides an actual or potential real property investor, borrower, lender, appraiser, or assessor in optimizing the components of return on a real property, investment or loan, that is embodied in a computer-implemented web-based environment. The method of the present invention contains six major phases—Qualifying, Valuation, Developing and Deciding on Alternatives, Marketing, Negotiation and Closing, and the Post Closing Phase. The system guides the user in ordering and executing the method steps within each of the six major phases. The principle advantage of this invention is that the method of the present invention is a decision support system that provides those transacting business in these market a means of optimizing their return on investment by reducing transaction cost, time, uncertainty, and risk.

### FIELD OF THE INVENTION

The present invention is directed to a computer implemented and web-based system and method for optimizing return on investment in real property and/or a loan made with real property as security. More particularly the present invention is an expert system that provides a logical step by step decision making support system that assists and guides an actual or potential real property investor, borrower, lender, appraiser, or assessor in optimizing the components of return on a real property investment or loan. These components include cash flow, appreciation, and tax benefits, equity buildup and they require optimizing in order to achieve the user's investing, borrowing, lending, or valuing objectives. The method of the present invention includes guiding a user in ordering their data entries and decisions, auditing the calculated results of their data entries, reviewing the impact of their data entries on value, and using the results of their reviews to revise their data entries so as to maximize their return on investment.

### BACKGROUND OF THE INVENTION

Owners, prospective owners, lenders, and others (herein “investor”) need to be able to maximize their return on an investment in or a loan on real property. To accomplish this they need a comprehensive, fully integrated method of qualifying potential transactions, valuing properties, structuring the financing, identifying the combination of economic assumptions that will maximize a property's value, provide a means of developing and evaluating alternatives such as building improvements on existing raw land, improving the property and or trading it. In addition investors need a more perfect market in which to conduct real property transactions along with the ability to exercise more control over the negotiation process in executing such transactions. Finally, potential investors need a way to carry over the financial projections done to acquire a property into their ownership period and use that information as a base line to make better decisions regarding lease negotiations, improvements, potential trades and a wide variety of other decisions.

The need begins when considering a real property transaction such as a purchase, sale, or financing where real property will be security for the loan. At this point in the investment or lending cycle, the investor needs to determine the feasibility of successfully executing the transaction under consideration at their desired target value, and if the transaction cannot be executed at the desired target value, and guiding the investor in identifying the lowest cost changes that can be made to the property in order to make the transaction feasible at the desired target value.

The next step in the investment/lending cycle is performing a detailed valuation of the property in its present condition. There are several existing software programs that perform this discrete function but do not provide the additional guidance needed to maximize return on a real property investment or loan. Along with valuing a property, the investor needs to be able to structure the financing to meet their cash flow objectives along with identifying capital and leasing expenditures funded from cash flow. There are several existing software programs that perform a portion of this discrete function but do not provide the additional guidance needed to maximize a return on a real property investment or loan.

The investor needs to be able to develop and evaluate investment alternatives such as improving the property to reposition it within its market to command higher rents, reduced expenses, and a lower capitalization rate. To be meaningful such an evaluation needs to indicate the financing needed to make the improvements and be able to compare the financial performance of the property in its current condition with what can be expected after the improvements are made. This repositioning analysis needs to be done without duplicating the work required to value the property but rather build on the existing valuation.

The investor also needs to be able to evaluate the feasibility and desirability of trading the property pursuant to Section 1031 of the internal revenue code. Here again evaluating the desirability and feasibility of trading the property needs to be done without duplicating the work required to value the property but rather building on the existing valuation to craft a comparison showing the changes in performance over an extended period if a new property is acquired pursuant to Section 1031 of the Internal Revenue Code.

Investors have different objectives that range from passive to entrepreneurial and in between and need to be able to identify purchase, borrowing, and lending opportunities that match their objectives. In this regard both potential investors and lenders need a way of scoring or rating a property in terms of performance measures such as its price, ability to service debt, expected downtime between tenants, and the projected year over year appreciation.

The current real property market is one of the economy's most inefficient and imperfect markets. Investors need a central place to identify real property opportunities the economics of which can be can be evaluated and acted upon. The potential investor and lender need to be able to have more immediate access to the information used by the owner to value a property that is posted in search of a buyer or lender.

Finally, potential investors need a way to carry over the financial projections into their ownership period and use that information to make better decisions during lease negotiations, planning improvements, evaluating potential trades and a wide variety of other decisions.

Outside of the availability of software to value a property and websites that allow individuals to post listings for sale without the ability for potential buyers and lenders to access the underlying economic assumptions and act on the information provided, nothing is being done. To make up for the lack of a fully comprehensive, integrated method of maximizing return on investment, many investors hire specialist in various areas to fill the gaps between what investors need and what is currently available. These include specialists such as appraisers, brokers, and accountants.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle advantage of this invention is that the method of the present invention is a decision support system that provides those transacting business in these markets a means of maximizing their return on investment by reducing transaction cost, time, uncertainty, and risk.

Another advantage of this invention is the method of the present invention will also make the real property markets a more efficient and perfect place to conduct real property transactions.

Another advantage of this invention is that it applies to real property which includes but is not limited to commercial real estate, raw land, residential real estate including single family dwellings as well as multifamily properties, and includes real property such as boat slips, mini-storage facilities, and commercial and residential condominiums for sale.

Another object of this invention is that it provides an expert system that provides a logical step by step decision making support system that assists and guides an actual or potential real property investor, borrower, lender, appraiser, or assessor in optimizing the individual components of return on a real property investment or loan to maximize overall return.

Another object of this invention is that these components include cash flow, appreciation, tax benefits, and equity buildup and these components require optimizing in order to achieve the user's investing, borrowing, lending, or valuing objectives.

Another object of this invention is that it facilitates optimization for the passive investor whose objective may be to optimize the combination of cash flow, appreciation, and tax benefits to reach their ultimate objective—maximizing a secure stream of cash flow payments over an extended holding period.

And yet another object of this invention is that it facilitates optimization for a purely entrepreneurial investor who will want to optimize the combination of cash flow, appreciation, and tax benefits to maximize their ultimate objective of appreciation over a shorter holding period than the passive investor.

And another object of this invention is that in each case the method of the present invention assists the investor in identifying and putting the property to its highest and best use in order to achieve the investor's objectives.

The method of the present invention contains six major phases—Qualifying, Valuation, Developing and Deciding on Alternatives, Marketing, Negotiation and Closing, and the Post Closing Phase. Each phase includes detailed steps to assist and guide the user. The system guides the user in ordering and executing the method steps within each of the six major phases.

The method of present invention is a step by step process designed for ease of use and includes Anticipatory Help™ so that when the insertion point is focused in a data entry box the “help” for that entry box appears. In addition, help contains a glossary of terms that is accessed by simply clicking on the term in question and the glossary for that term appears. If the user is interrupted and closes or exits the system, the system remembers where the user was in the process and when the user returns to continue working on a property, the system tells them where they previously left off.

Qualification Phase

The first step in the method of present invention is qualifying. Real property owners, potential buyers, and lenders all need a quick accurate way of previewing and testing the proposed terms of a transaction to determine their feasibility before introducing the proposed transaction to the market. Whether the value of the property is to be maximized, minimized, or reasonably valued, the permutations and combinations of factors driving value need to be previewed and tested to determine their ability to achieve the desired goal. In the end it is the optimal set of terms that should find its way into the offering memorandum, or an offer to purchase or lend as it is this set of terms that will provide the person negotiating on behalf of an owner, potential buyer, or lender with the facts and arguments needed to support their negotiation objective.

Today, owners, prospective owners, lenders, and others have no effective method of testing the many combinations of economic assumptions to identify the one set that will produce the most effective opening offer in a real property transaction. Absent the ability to pre-qualify the economic assumptions underlying the offering terms of a transaction, a party wanting to complete a transaction today simply initiates the transaction to see if it will close at the desired target price. A party can expend substantial time, effort, and money only to see a transaction fail. If the transaction fails, the cost of failure goes well beyond the out of pocket costs of time, effort, and money. The cost of failure also includes the property becoming “shopped” thereby tarnishing the property's reputation in the market and making it harder to sell on more reasonable terms at that time or at a later time. Even if the transaction closes, the closing terms that might have been available are compromised by the fact that the negotiation was initiated using an opening offer that reflected less than the most advantageous terms.

As the user progresses in qualifying the proposed transaction, they gather information that describes the property, its tenants, and market within which it exists. This data is stored in Preliminary VP Profile™. This information will be used to acquire the information needed to complete VP Profile™ and identify and acquire the comparable lease and sale information used by Target Matrix™, and other data used by VP Score™ and VP Market™

Depending on the user's needs, some combination of, Developer ScratchPad™, ScratchPad™, VP Solver™, and Target Matrix™, can be used to qualify the terms of a proposed transaction to determine its feasibility and desirability. VP Solver™ and Target Matrix™ provide the user with guidance regarding rental rates and the capitalization rate required to achieve the user's desired target price.

Developer ScratchPad™ is used to estimate the cost of developing raw land or making physical improvements to existing buildings thereby qualifying, testing, the feasibility and desirability of doing so. Developer ScratchPad™ can also be used to value raw land to determine its highest and best use and its value at lesser uses given different types of for lease improvements that can be built on the land. The party planning to develop raw land can use the system's Occupancy Cost feature to compare the economics of their offering lease rates with their competitors. This feature can also be used to manage lease negotiations to identify the most advantageous combination of lease terms and optimize those terms.

ScratchPad™ is used to estimate the value of improved real property by optimizing the factors that drive value. Using ScratchPad™, a user can quickly arrive at the supportable combination of factors that will produce the highest value. These factors include rent per square foot, miscellaneous income, vacancy, credit losses, tenant reimbursed expenses, operating expenses, and capitalization rate.

VP Solver™ provides the user with the ability to enter a desired target value and ScratchPad™ will quickly calculate the rent per square foot required to achieve the desired target value.

An additional use for ScratchPad™ is as a pop up in a mapping program. In this manner a user clicking on a building(s) will have immediate access to ScratchPad™. The same pop up can also can be used to identify a building(s) as being for sale in VP Market™.

If VP Solver™ produces a rent that is not currently in place with existing tenants, or a rent that is not currently available in the market, the user moves on to Target Matrix™ where an array of values are presented based combinations of rents and capitalization rates. The rents and capitalization rates can be those based on comparable leases and sales or from asking rents and prices in the market. In this manner Target Matrix™ provides the user with several different combinations of rent and capitalization rate that will produce the desired target value. Later, after valuing the property in its present condition, the user can employ the Repositioning™ Analysis to assess the benefits of investing to make physical improvements to the property thereby repositioning the property in the market to command higher rents and or a lower capitalization rate.

Valuation Phase

If the Qualification Phase indicates the terms of the proposed transaction are achievable, or the property can be repositioned to make the proposed terms achievable, the user proceeds to the Valuation Phase where the value of the property is ascertained using either the Income Approach To Value or discounted cash flows. The Valuation Phase includes five major steps—Valuation, Structuring the Financing, DealMaker™, a discounted cash flow valuation, and VP Profile™.

The Valuation begins with Property Detail where basic information describing the physical characteristics of the property are entered into the system. The property is entered on a property list with other properties that have been qualified or valued. In addition, the user can elect to Share the valuation with others. Sharing a valuation can give others viewing rights which allows them to view the valuation, or edit rights which provides the real time ability for additional individuals to not only view the valuation but contribute to it by entering data used in the valuation. Share is particularly useful when members of a team are at differing locations and are tasked with collaborating to Qualify, Value, Developing and Decide on Alternatives, Marketing, Negotiation and Closing, and Post-closing activities. This is also useful when one member of the team is doing the data entry while other members of the team are focused on other aspects of maximizing return on investment. In addition to Share, access to a valuation can also be requested using VPMarket™. Requesting access to a valuation can be done by team members as well as potential buyers and lenders.

As the user moves forward with the valuation, they enter the parameters of the valuation such as the period of the valuation, whether the income approach to value or discounted cash flows will be used to value the cash flows, and the method of estimating the property's operating expenses. These entries are followed by entering the Sale Capitalization Rate along with the Going Out Capitalization Rate and planned Capital Expenditures and Reserves.

In each case where data is entered and system calculations are performed, the system automatically produces audit reports where the user can check the data entries and calculations for accuracy. This is unique to the method of the present invention and prevents what would otherwise be undetectable errors from adversely influencing the quality of the user's decision making process. In addition the system flags Suspicious Items™ which are usually data entries that are outside their expected range or create undesirable results such as periods of negative cash flow or capital expenditures in excess of capital reserves which the user can then reschedule or downsize.

As part of both the Income Approach to Value and the discounted cash flow method of valuation, the economics associated with each tenant's lease are entered in the Rent Roll Detail section and the system calculates the resulting net operating income produced by that tenant which is then added to that produced by the other tenants to arrive at Total Net Operating Income for each year in the valuation period. In calculating the net operating income generated by a specific tenant, the Rent Roll Detail for that tenant allows the user to describe the economics associated with the tenant's lease including the lease terms dealing with expenses. For example does the tenant reimburse the owner for all expense, just certain expenses, or for none of the expenses? The user goes on to describe rent escalations and any rent abatement included in the tenant's lease.

After entering the economics associated with each tenant's lease the user then enters a Releasing Assumption for the suite the tenant occupies. A Releasing Assumption can be for a suite, a part of a floor or one or more floors in a building. Entering information describing the Releasing Assumption, the user is defining the expected term of a new lease for the suite, its market rent, rent escalations, tenant improvements cost for a new tenant and for the existing tenant should they renew, potential downtime after the existing lease expires, the probability the existing tenant will renew, and the leasing commissions required for a renewing tenant and those required if the existing tenant does not renew.

The system also provides the ability for investors who range from passive to entrepreneurial to develop and evaluate, given their specific investment objectives the most advantageous economic terms on which to renew an existing tenant's lease or attract a new replacement tenant for a suite.

At this point the system once again generates audit reports so the user can check for and eliminate errors that if left undetected and corrected will adversely influence their decision making.

The last step in the Income Approach to Value is entering Other Income such as income from parking, storage, or cell tower facilities that have been leased.

If the user did not select the discounted cash flow method of valuing the property, the system uses the Sale Capitalization Rate that was entered at the outset of the valuation to calculate the property's value based on its calculated Net Operating Income for the year following the end of the Valuation Period that was selected at the outset of the valuation.

From here the user can elect to determine the effect of placing no financing on the property or a variety of different first and second loans. This is done in the Structure the Financing step and includes the ability to model the impact of an all cash transaction, a new or assumed first loan and second loans that are either interest only or amortized and in each case or combination of loans their impact on cash flow, loan to value, and debt coverage can be immediately viewed and adjusted to meet investor objectives. The result of placing financing on the property is stored in VP Profile™ and is also made available to the user in the next step—DealMaker™

As the user moves through the steps in Valuation, the information entered along with the results of system calculations is subjected to the system's “Suspicious Items” test and stored in VP Profile™. As data is entered at each step the system identifies suspicious entries and flags them for the user to reconsider. For example, if the loans placed on the property cause the cash flow for a period to turn negative, the user is alerted. The cause may be vacancy due to down time between tenants, planned capital expenditures, or some other factor that impacts cash flow.

Deal Maker™

At this point, the system has calculated the following measures of value: Net Operating Income, Value, Value/Square Foot, Cash Flow, and Cash on Cash Return for each year in the valuation period. These values are displayed in the Valuation Summary for the user's review and evaluation. DealMaker™ provides the user with the ability to optimize the factors driving these measures of value by presenting these factors in the order they have the ability to impact value.

Using DealMaker™ the user can make changes to factors such as the Capitalization Rate, Financing, Releasing Assumptions, and the other factors that drive value. These are presented to the user in the order changes to them impact value.

Once the measures of value have been optimized the user, if they have elected, can value the property based using the discounted cash flow method and produces a matrix of Internal Rates of Return (IRR). To begin this step the user is presented with the items that are funded from cash flow such as tenant improvements, leasing commissions, furniture, fixtures, and equipment (FF&E), Capital Reserves and Lump Sum Capital Expenditures. The values presented can be for 1 to 20 years depending on the valuation period selected by the user. From here the system calculates the Residual Value of the property—the net proceeds of sale at the end of the valuation period.

At this point the system presents the user with a table of values showing IRR, Price/Per Square Foot, Capitalization Rate, First Loan to Value Ratio, and the property's Cash On Cash Return at various internal rates of return. The user enters the desired Offering Sale Price based on their evaluation of the different measures of value set forth in and the system returns the Leveraged IRR and Unleveraged IRR at the selected Offering Sale Price.

VP Profile™ and VP Score™

As the user progresses through the steps of the method of the present invention the system stores data used to complete the valuation and structure the financing whether it was entered by the user or obtained from external sources. This information includes data describing the property, its tenant, the property's market, area, regional and national economic data, and data describing the owner which can include the owner's credit rating and or other information such as cash operating reserves.

In the end, the system uses VP Score™ to scores the property in terms of its ability to satisfy the objectives of a passive investor on one hand, an entrepreneurial investor on the other hand and those in between these two extremes. The items scored include but are not limited to the property's price per square foot, the ability of the property to service debt, downtime between tenants, and the expected appreciation by valuation year.

Developing and Deciding on Alternatives

RePositioning™ Analysis

If the user completed the qualification process using Target Matrix™ and proceeded to complete the Valuation Phase, the user can now evaluate the feasibility and desirability of making improvements to the property to command higher rents and a lower capitalization rate. This is done using the RePositioning™ Analysis.

To begin this analysis, the user enters the data required to calculate the property's financial performance after the improvements have been made along with any financing required to make the improvements. The financing entries include any funds the owner wishes to take out of the property by way of placing a loan on the property in excess of what is needed to pay off existing loans for the planned improvements.

The cost of the improvements required to reposition the property in its market along with the desired free and clear return can be estimated using Developer ScratchPad™. When the data is entered, the system presents the user with a comparison of the property's existing financial performance with an estimate of the performance that will result from improving the property. At this point the user can adjust the inputs describing the property's performance after improvement until they are satisfied they have maximized the performance of the property given their objectives.

### TradeUp™ Analysis

If the user believes trading the property pursuant to Section 1031 of the Internal Revenue Code will maximize their return on investment, they can evaluate that alternative by performing a TradeUp™ Analysis.

The user begins by defining the financial performance of the target property (the one to be acquired in the trade). Once the user has accomplished this, the system provides a comparison of the existing property and the target property in terms of the changes in Operating Cash Flow, Market Value and Equity over a 10 year period. Here again the user can adjust the factors defining the performance of the target property until the user believes they can be realized in a trade.

Marketing Phase

VP Package™

As the valuation phase has progressed, the system has been using data stored in VP Profilc™ to create reports that are now available for inclusion in the marketing package—the Offering Memorandum. To assemble a marketing package the user selects the reports they want to include from a list of available reports presented in the system's Package Detail step. Here the user selects the desired reports which are pre-populated with most of the information for their publication. If the desired reports are not completely pre-populated, the user is prompted to complete them by entering the additional information, pictures, and or data.

When the user has selected all the reports needed, he simply clicks a button to create a package file which can be published in a variety of formats including the portable document (pdf) format or directly to VPMarket™.

VP Market™

VP Market™ is a website where properties that are for sale or trade or in need of financing can be listed to aid in identifying buyers and lenders. Here a seller can identify a property and its score in the range of risk as a passive to entrepreneurial investment or lending opportunity. When a potential buyer or lender includes a target risk score in their target property profile, the system ranks the search results by the difference between their target risk score and the risk score of the posted property with the property with the smallest difference being ranked first down to the property with the largest difference. Potential buyers and lenders can also use the system's Notify Me™ feature to be automatically notified when properties that meet their criteria are posted for sale or financing.

VP Market™ also differs from other such listing websites in that an interested buyer or lender can contact the person who posted the property to the website and the person posting the property can use the Share feature of the present invention to immediately allow the person who is inquiring to make a copy of the entire valuation along with edit rights. The interested party can then make a copy and use the copy to optimize the factors that are important to them to determine the property's ability to meet their investment or lending objectives. If they want to return to the original that was shared with them, it is still in its original form as their changes were made to a copy.

For the properties valued using the method of the present invention will be posted to VP Market™, all the parties to a potential transaction are using the same method of valuation which provides a degree of transparency and efficiency that is otherwise not available. The search and ranking capability of VP Market™ is a major step toward achieving a more perfect and efficient real estate investment market. This level of transparency can substantially reduce the due diligence period and avoid many time consuming and costly misunderstandings. The transparency enables a potential buyer or lender to drill down into an owner's analysis and see all the assumptions the owner has made in valuing the property along with the audit reports that were generated at each step.

An additional use of VP Market™ is to feed property for sale data to mapping software where it can be searched. ScratchPad™ would also be included to allow interested parties see a summary of how the property was valued and quickly value mapped properties using their own financial assumptions regarding the property's performance.

Negotiation and Closing Phase

If the interested party wants to move ahead and negotiate with a view toward purchasing or lending on the property, the negotiation can move forward in the traditional manner with offers and counter offers. In the alternative, a user can employ the system's “Bargain to Goal” App to assist in achieving a party's goal based on making smart counter offers as they move through the negotiation phase.

The system's “BaseLine™ feature is also helpful as it can identify the changes the other party to the negotiation has made to the valuation to arrive at their latest counter offer. In addition, VP Market™ can also be used to exchange and execute the documents required to close the transaction.

Post Closing Phase

After a sale transaction closes, the buyer can use the valuation that reflects the closing price to identify the optimal lease terms when negotiating to Renew or Replace™ tenants; deciding on new financing; repositioning the property; or at some point, which the system will assist in identifying, selling or trading the property. Over the time the buyer, the new owner, holds the property BaseLine™ provides the new owner with a way of comparing the financial impact of their decisions regarding such actions as new leases, financing, repositioning the property with the assumptions used to value it when they decided to purchase it. In addition, BaseLine™ will identify and tract the impact of their decisions on the specific measures of value that are affected by their post-closing decisions.

### SUMMARY

The real property purchase, sale, and lending market is one of the economy's most inefficient and imperfect. From conception to execution, transactions take too much time and are plagued with enormous uncertainty, a lack of transparency, and the lack of a standard method of valuation. Individuals and companies using the method of the present invention can maximize their return on investment by minimizing the impact of risk and these market imperfections in their real property dealings.

The steps and features included in the method of the present invention combine to make the market more efficient and perfect along with equipping a user with the following specific benefits:
Reduce the time and effort required to identify the optimal economic terms to be included in the Offering Memorandum—The Sale Package
Compare the owner's proposed lease terms with those offered by competitive buildings
Increase the certainty that once offered to the market, a property will sell or attract a lender willing to lend on acceptable terms
Easily identify the rent required to achieve a desired target value
Easily identify the rent and capitalization rate that will produce a desired target value.
Value a property with the ability to audit entries, calculations, and detect suspicious data entries.
Use the system's Share feature to collaborate in real time with others in valuing a property even though they are in different locations.
Use VP Profile's™ VP Score™ feature to make it easy for interested buyers and lenders to identify a property as a worthwhile opportunity given their objectives
Given an investor's objectives Renew or Replace will optimize negotiated outcomes when deciding to renew or replace-a tenant.
Employ DealMaker™ to control the different factors driving value to achieve specific investment or lending objectives.
VP Score™ is a risk analysis that rates properties, markets, the economy, and owners which makes it much easier to match investing or lending objectives with the appropriate property of lender.
Use the RePositioning™ and TradeUp™ Analyses to develop and evaluate alternatives that can optimize return on investment.
Post the Offering Memorandum on VP Market™ to attract qualified buyers and lenders and reduce transaction time by sharing an editable copy of the owner's valuation with interested parties.
Use the system's one click feature to assemble the desired reports into an Offering Memorandum.
Use “Bargain To Goal™” to produce improved negotiated outcomes by developing and making smarter concessions to gain more control over the bargaining process.
Use the system's Baseline™ feature to optimize decision making during a purchase and sale or lending negotiation and as a new owner makes decisions intended to maximize their return on investment.

It must be clearly understood at this time although the preferred embodiment of the invention consists of a system and method comprising an expert system that provides a logical step by step decision making support system that assists and guides an actual or potential real property investor, borrower, lender, appraiser, or assessor in optimizing the components of return on a real property investment or loan, that is embodied in a computer-implemented web-based environment, or combinations thereof, that other avenues of deployment will achieve a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A depicts a flow chart of VP CRE™ decision support system and method in a general broad overview illustrating the sequence and order of the system phases and method steps;

FIG. 1B depicts a computer implemented, web-based or cloud environment in which the system can be constructed and the method can be operated;

FIG. 2 depicts a flow chart of the VP CRE™ decision support system and method in an overview illustrating the sequence and order of the system phases;

FIG. 3 depicts a screen where the user enters a description of the Qualification being undertaken;

FIG. 4 depicts a flow chart/decision tree of Developer ScratchPad™ illustrating the sequence and order of the method steps;

FIG. 5 depicts a Developer ScratchPad™ screen where a user enters the data requested and the system calculates and presents to the user with the costs and measures of value;

FIG. 6 depicts another Developer ScratchPad™ screen where a user enters the data requested and the system calculates and presents to the user with the costs and measures of value;

FIG. 7 depicts a competitive occupancy cost analysis process which helps a party in a lease negotiation identify the cost of leasing a target property so it can be compared to competitive properties;

FIG. 8 depicts a continuation of the competitive occupancy cost analysis process including the cost of non-rental cost elements included in the occupancy cost plus the total occupancy cost for the lease term along with the net present value of the total occupancy cost which can be compared with competitive properties.

FIG. 9 depicts a flow chart/decision tree of ScratchPad™ and VP Solver™ illustrating the sequence and order of the method steps used to quickly value and qualify improved real property;

FIG. 10 depicts a ScratchPad™ and VP Solver™ screen where a user enters the data requested and the system calculates and presents the user with income, costs, and measures of value;

FIG. 11 depicts a flow chart/decision tree for Target Matrix™ illustrating the sequence and order of the method steps;

FIG. 12 depicts a screen where the user describes the property and its submarket;

FIG. 13 depicts another screen where the user describes the property and its submarket;

FIG. 14 depicts a screen that provides a place where the user can initiate a search for lease and sale comps and view lease and sale comps brought into the system electronically or manually;

FIG. 15 depicts a typical Target Matrix™ screen that is produced by the decision support method of the present invention;

FIG. 16 depicts a property list that identifies and describes the properties which have been entered;

FIG. 17 depicts a screen used to enter information describing the property including the buildings that make up the property;

FIG. 18 depicts a flow chart/decision tree of the Valuation Phase of VP CRE™, and the sequence and order of its method steps;

FIG. 19 depicts a valuation list which presents the user with a list of the valuations that have been begun and or completed for a given property and whether the valuation has been shared, and if so who with, and whether the person the valuation was shared with has edit or view;

FIG. 20 depicts a data entry screen where users make their initial selections regarding the type of valuation to be done and enter the data requested;

FIG. 21 depicts a the screen where the information describing the Expenses on a Dollar per Square Foot basis is entered for this type of valuation;

FIG. 22 depicts screen where a user enters the expenses for a valuation that has a detailed schedule of expenses which is the most accurate method of estimating expenses and is the step in the decision support process where the user enters amounts for each type of expense being incurred to operate the property and its expected annual rate of increase;

FIG. 23 depicts more expenses of a valuation that has a detailed schedule of expenses;

FIG. 24 depicts a link that takes the user to an expense audit screen and the Valuation Year 1 expense audit screen the user is taken to;

FIG. 25 depicts an expense total audit screen where the user can review the total projected operating expenses and the total operating expense per square foot for each year in the valuation period;

FIG. 26 depicts a tenant list where the user can enter a new tenant, access a tenant's details copy or delete a tenant lease;

FIG. 27 depicts a rent roll detail screen where each tenant's name and the additional information describing the tenant's lease is entered;

FIG. 28 depicts another portion of the rent roll detail screen which provides a user with the ability to associate the tenant with releasing assumptions which are used to estimate the financial impact of a lease expiration including the loss of income due to downtime, tenant improvement costs, leasing commissions, and an eventual new leases impact on the property's net operating income and cash flow;

FIG. 29 depicts a screen where the user can modify the expense terms of a full service or triple net lease by checking the boxes identifying expenses that the tenant reimburses the owner for or pays directly to an outside vendor;

FIG. 30 depicts a screen where the user can create a user defined rent escalation for leases where increases take place on other than lease anniversary dates for any year during the lease period;

FIG. 31 depicts a screen illustrating suite rent abatement if free rent is offered at times other than at the beginning of the lease, or at times in addition to the beginning of the lease;

FIG. 32 depicts a screen illustrating a list of valuations releasing assumptions (RLAs);

FIG. 33 depicts a screen showing a releasing assumption (RLA) detail where the user decides on the elements of each new releasing assumption;

FIG. 34 depicts a screen showing how renew or replace options can be evaluated to support the user's decision making process in negotiating to renew leases or replace tenants when a lease expires;

FIG. 35 depicts a continuation of the releasing assumption (RLA) detail screen showing which suites are assigned to an RLA support the user's decision making process and by clicking on the RLA Audit link which takes the user to the screen entitled “RLA Audit,” rent roll details and/or rent roll summary;

FIG. 36 depicts an audit report (“RLA Audit”) which shows the financial impact of the RLA on income as suites on the third floor are leased and leases on the third floor expire and are released;

FIG. 37 depicts a screen illustrating the rent audit reports menu, and a Valuation phase Rent Escalation Audit report;

FIG. 38 depicts a Valuation Phase rent roll audit rent abatement report;

FIG. 39 depicts a Valuation Phase Rent Roll Audit Expense Reimbursement report;

FIG. 40 depicts an audit report showing the projected Tenant Expense Reimbursement for the Valuation Period plus one year;

FIG. 41 depicts a Rent Roll Audit for Suite #103 where the user can review the amounts produced by the entries that create Base Rental Income, lost income from Abatement and Downtime between tenants, Reimbursement Income and finally Rent Roll Audit Income total suite income;

FIG. 42 depicts a screen where the user identifies and enters the sources and amounts of Other Income including User Defined Sources of Other Income;

FIG. 43 depicts a Sale Price & Offering Price Sale Price Calculation Based on the Income Approach To Value, where at this point in the decision support process, the system produces an Operating Income Statement that includes Net Operating Income, the Sale Capitalization Rate, Selling Price, and Price per Sq. Ft., and supports the user's decision on entering the offering sale price for the property with the resulting capitalization rate and Offering Price per Square Foot;

FIG. 44 depicts a detailed flow chart/decision tree illustrating the sequence and order of the method steps in structuring the financing;

FIG. 45 depicts a Structure the Financing screen which presents the user with the opportunity to enter data describing the loans, if any, they plan to place on the property and the results of the decisions they make defining the financing of the property including the impact on cash flow and cash on cash return of any First and Second Loans;

FIG. 46 depicts a detailed flow chart/decision tree of the DealMaker™ method illustrating the sequence and order of the method steps, showing the input entries made defining the value of the factors that drive a property's value in the order in which they do so;

FIG. 47 depicts a Valuation Summary screen, where having entered the required data to this point, the user can review the impact of their decisions to this point and refine their decisions to arrive at their target value for the property;

FIG. 48 depicts a portion of the DealMaker™ screen where the system of the present invention presents the most powerful influences on the value of a property in the order of their ability to impact value where the user can review and change the data or click to review relevant reports and data entry screens in order to maximize return on investment;

FIG. 49 depicts another portion of the DealMaker™ screen showing the remaining items that influences the value of a property in the order of their ability to impact value wherein the user can review and change the data or click to review relevant reports and data entry screens in order to maximize return on investment;

FIG. 50 depicts a portion of the Valuation Phase Internal Rate of Return (IRR)—specifically the Pre-tax Cash Flows and Residual screen;

FIG. 51 depicts another portion of the Valuation Phase Internal Rate of Return (IRR) screen where the user enters a range of IRRs within which the system of the present invention guides and supports the user by calculating and presenting the Price per Square Foot, Sale Price, Capitalization Rate, First Loan to Value Ratio, and Cash on Cash Return that are associated with the different Internal Rates of Return thereby aiding the user deciding on an Offering Price and when the offering price is entered, the system calculates and displays the Offering Capitalization Rate, Leveraged Internal Rate of Return and the Unleveraged Internal Rate of Return;

FIG. 52 depicts a detailed flow chart/decision tree of that portion of VP Profile™ termed VP Score™ that illustrates the sequence and order of the method steps used to score the a property in terms of its ability to meet investment objectives ranging from a low risk passive investment to a higher risk entrepreneurial investment and in between;

FIG. 53 depicts a detailed flow chart/decision tree illustrating the sequence and order of the method steps used to evaluate the feasibility and desirability of making physical improvements to a property thereby repositioning the property to increase its value by increasing its ability to command higher rents and/or a lower capitalization rate;

FIG. 54 depicts a RePositioning™ Proforma screen where the user describes the desired economic performance of the property after the property has been improved and repositioned in its submarket;

FIG. 55 depicts a RePositioning™ Summary screen, where once the user enters the data required in FIG. 54 the system calculates and presents the Repositioning™ Summary allowing the user to compare the property's existing economic performance with that expected after improving the property;

FIG. 56 depicts a flow chart/decision tree illustrating the sequence and order of the method steps involved in evaluating the feasibility and desirability of entering into a tax deferred exchange pursuant to Section 1031 of the Internal Revenue Code;

FIG. 57 depicts the TradeUp™ Proforma data entry screen where the user defines the desired economic performance of the target property, the as yet un-named property that the user will trade into if such a property can be found;

FIG. 58 depicts a Developing and Deciding on Alternatives—TradeUp™ Performance screen which presents the user with the expected changes in economic performance if the trade is executed and the target property is acquired along with the sale price and debt associated with the target prop as those are important benchmarks to qualify for tax deferral;

FIG. 59 depicts a detailed flow chart/decision tree for VP Package and illustrates the method steps of the present invention used to create and publish an offering memorandum—as a marketing package or to a digital marketplace called VP Market™;

FIG. 60 depicts a Market Phase—VP Package™—Package List screen where the user can Create a New Package, view the Details associated with an existing Package, Copy an existing Package, or Delete an existing package;

FIG. 61 depicts a Package Detail screen where the user describes and names the package they are about to create and identifies the reports they want to include in the package/offering memorandum;

FIG. 62 depicts a screen for the user to supplement information already stored in the system of the present invention for the Front Page for the Offering Memorandum;

FIG. 63 depicts a Package Options—Executive Summary screen where the user supplements the information already stored in the system of the present invention to complete the Executive Summary. The information already in the system pre-populates the text boxes;

FIG. 64 depicts a portion of the Package Options—Property Description screen where the user supplements the information already in the system to complete the description;

FIG. 65 depicts another portion of the Package Options—Property Description screen where the user supplements the information already in the system to complete the description;

FIG. 66 depicts a Package Options—Lease Comp List where the user can view a list of the existing Lease Comps, Enter New Lease Comp, view the Details of an existing Lease Comp, or Delete a Lease Comp;

FIG. 67 depicts a Package Options—Lease Comp—Lease Comp Detail screen where if the user clicked on “Enter New Lease Comp in FIG. 66 they were taken here where they enter information describing a new Lease Comp;

FIG. 68 depicts a Package Options—Sale Comp List screen where the user can view a list of the existing Sale Comparables (Sale Comps), Enter New Sale Comp, view the Details of an existing Sale Comp, or Delete a Sale Comp;

FIG. 69 depicts a Package Options—Sale Comp Detail screen where if the user clicked on “Enter New-Sale Comp in FIG. 68 they were taken here where they enter information describing a new-Sale Comp;

FIG. 70 depicts a Marketing Phase—Package Options, Create Package File screen where the user can click the button to create an offering memorandum comprising the valuation and other reports chosen for the Package which will be published to locations selected by the user;

FIG. 71 depicts a flow chart/decision tree illustrating the sequence and order of the method steps involved in preparing to introduce and introducing the property to prospective buyers and or lenders;

FIG. 72 depicts a flow chart/decision tree of the Negotiation & Closing Phase of VP CRE™ illustrating the sequence and order of the method steps, showing the method of negotiating as traditional or via an integrated messaging system;

FIG. 73 depicts a Bargain To Your Goal™ screen which is available to assist a party in crafting effective offers and counter offers so as to advance the user's interests during the bargaining phase where the final economics of the transaction will be decided and settled on;

FIG. 74 depicts a flow chart/decision tree of the Post Closing Phase where once the transaction that was the subject of the negotiation closes an owner who traded, placed financing on a property, an owner who repositioned a property, or a buyer who purchased a property, can make a live copy of the valuation reflecting the results of the negotiation and make changes to it as decisions regarding new leases or other actions are taken and use BaseLine™ to identify the impact of proposed changes on the financial performance of the property.

### DETAILED DESCRIPTION OF THE PREFERRED EMBODIMENTS

For a fuller understanding of the nature and objects of the invention, reference should be had to the following detailed description taken in conjunction with the accompanying drawings wherein similar parts of the invention are identified by like reference numerals. There is seen in FIG. 1A a VP CRE™ Broad General Overview depicting a flow chart of the VP CRE™ decision support system and method in a general broad overview illustrating the sequence and order of the system phases and method steps, showing the qualification phase, valuation phase, developing and deciding on alternatives phase, marketing phase, all leading up to and culminating in the negotiation and closing phase followed by the post-closing phase.

FIG. 1B depicts a computer implemented, web-based or cloud environment in which the system can be constructed and the method can be operated, including deployment options including but not limited to desktop computers, Smartphones, notebook computers, tablets and other wireless devices.

FIG. 2 depicts a flow chart of the VP CRE™ decision support system and method in an overview illustrating the sequence and order of the system phases showing the:

Qualification Phase
Developer ScratchPad™
Occupancy Cost
ScratchPad™
VP Solver™
Preliminary VP Profile™
Target Matrix™

Valuation Phase
Valuation—Using the Income Approach to Value or Discounted Cash Flows
Structure the Financing
DealMaker™
VP Profile™

Developing & Deciding on Alternatives
RePositioning™ Analysis
TradeUp™ Analysis
Renew or Replace

Marketing Phase
VP Package™
VP Profile™/VP Score™
VP Market™

Negotiation and Closing Phase

Post Closing Phase

Qualification Phase

FIG. 3 Qualifying Phase—Qualify, is the screen where the user enters a description of the Qualification being undertaken. When a description of the qualification and the property's name are entered, the date the qualification is “Created” is presented to the user. At the same time the system adds the property by name to the Property List and the description of the qualification being done to the Valuation List. In this way the system saves the qualification for future retrieval and use.

FIG. 4 Qualifying Phase—Developer ScratchPad™ depicts a flow chart/decision tree of Developer ScratchPad™ illustrating the sequence and order of the method steps as follows:

Land Cost

Site Preparation Cost

Construction Cost

Professional Fees & Taxes

Tenant Improvements

Leasing Commissions

Developer Fee

Total Project Cost before Points & Interest

Construction Financing

Total Project Cost

Required Net Operating Income

Required Gross Scheduled Income

Other Income

Suite Income

Required Rent/Net Rentable Square Foot

Capitalization Rate

Project Value

FIGS. 5 and 6 Qualifying Phase—Developer ScratchPad™ depicts a screen where a user enters the data requested and the system calculates and presents to the user with the costs and measures of value. The calculated costs and measures of value assist the user in determining the feasibility and desirability of developing a parcel of raw land further developing an improved parcel with available raw land, or making improvements to the existing improvements to increase property value.

The Development Proforma resulting from the calculations can be used to obtain equity, financing, or for inclusion in an offering memorandum assembled to support the asking price if the property is marketed in its undeveloped condition. The results can also be used to estimate the cost and determine the feasibility and desirability of repositioning the property—making physical improvements to increase the property's rent and or lower its capitalization rate thereby increasing its value.

FIGS. 7 and 8 Qualifying Phase—Occupancy Cost Qualifying Phase—Competitive Occupancy Cost Analysis The Competitive Occupancy Cost Analysis helps a party in a lease negotiation identify the occupancy cost of leasing a target property and comparing it to competitive properties. This can be used to optimize the user's position in a number of leasing scenarios. This can also be a standalone App as well as part of the decision support system.

Here a developer/owner enters information describing the various costs of occupancy for tenants in competing buildings—buildings that the developer's new building or an owner's existing building will compete for tenants with when completed. These costs are entered based on the same number of usable square feet for each building in the comparative analysis and include costs and sources of income such as but not limited to rent, rent increases, rent abatement, expense pass-throughs to tenants, and parking. The developer or owner reviews the tenant occupancy cost in the competing buildings and then enters information describing the occupancy cost in the building he plans to build or lease. When he finishes entering information defining the various costs and income associated with occupying his new building, he can compare it to the competitive buildings in terms of:
Net Rentable Square Feet required to produce the desired usable square feet
Net Effective Rent offered by competitive buildings—how much free rent (rent abatement) is required to be competitive.
Parking Cost
Miscellaneous Cost
Expense Pass Throughs to tenants
Net Effective Occupancy Cost/Net Rentable Square Foot
Total Net Effective Occupancy Cost
Net Present Value of the Effective Occupancy Cost

After assessing his competitive position based on the above criteria, a developer can optimize it by modifying his entries in Developer ScratchPad™ and the Competitive Occupancy Cost Analysis until the optimal combination of Total Project Cost, Gross Scheduled Income, Net Operating Income, and Project Value are achieved. With the optimal combination of these terms identified, the developer can determine the feasibility and desirability of proceeding with development and construction.

In other scenarios the user might be a tenant evaluating different buildings with space for lease; an owner of an existing building evaluating the competition in preparing for and managing a lease negotiation with a prospective tenant: or a potential buyer evaluating a property for sale in terms of its ability to attract tenants on terms that will maximize their return on investment before moving forward to purchase the property.

In addition a user can grade and compare the amenities associated with a target property with those in alternative or competing buildings. Amenities can include average commuting time for employees, the building's prestige factor, proximity to restaurants, fitness facilities, and other facilities. The importance of each category is established and then, rated and scored.

FIG. 9 Qualifying Phase—ScratchPad™ and VP Solver™ depicts a flow chart/decision tree of ScratchPad™ and VP Solver™ illustrating the sequence and order of the method steps used to qualify improved property. To accomplish this, the user enters:
The six (6) data entries required to calculate a rough estimate of Net Operating Income.
An estimate of the property's market Capitalization Rate given the property's current condition.

After entering this information, the system calculates and presents the user with a rough estimate of the property's Selling Price/Value and Selling Price/Value per Net Rentable Square Foot.

If the calculated Selling Price is believed to be achievable, the user proceeds to execute the remainder of the decision support phases—the Valuation, VP TradeUp™, VP Package™, VPMarket™, and Negotiation Phase. If the rough estimate of the Selling Price produced by ScratchPad™ is not thought to be achievable given the property's current physical condition, the user proceeds within ScratchPad™ to VP Solver™ where the user enters the price they would like to achieve and Solver calculates the Rent per Net Rentable Square Foot required to produce the user's desired target value. From here the user proceeds to Target Matrix™ to identify the different combinations of rental rate and capitalization rate that will produce the desired target value.

FIG. 10 Qualifying Phase—ScratchPad™ is the screen where the following data describing the property is entered:

The property size in Net Rentable Square Feet

The Rent per Net Rentable Square Foot

Miscellaneous Income

Expense Reimbursement Income

Vacancy and Credit Loss

Annual Expenses per Net Rentable Square Foot

Capitalization Rate

Once the above data is entered, the system calculates and presents the user with the following rough estimates which indicate the property's ability to produce Base Rental Income, Potential Annual Income, Effective Annual Income, and Net Operating Income. The system also presents the user with a rough estimate of the property's Selling Price\Value. If the rough estimate of the Selling Price\Value is deemed to be achievable, the user moves forward with the effort required to complete a comprehensive valuation of the property.

If, on the other hand, the calculated Selling Price/Value produced by ScratchPad™ is deem to be unachievable given the property's current physical condition, the user proceeds to the VP Solver™ section of ScratchPad™. Here the user enters the Selling Price/Value they would like to achieve and VP Solver™ calculates and presents the user with the Rent per Net Rentable Square Foot required to produce the user's desired Selling Price/Value. From here the user proceeds to Target Matrix™ to determine the combination of rental rate and capitalization rate that will produce the user's desired target value.

FIG. 11 Qualifying Phase—Target Matrix™ depicts a flow chart/decision tree for Target Matrix™ illustrating the sequence and order of the method steps, showing VP Profile™ where data already residing in the system along with data entered into the system is stored and used to search third party data providers for comparable lease and sale information (lease and sale comps). The user interacts with the lease and sale comps causing the system to produce a matrix of values showing the property's Selling Price/Value for each combination of rental rate and capitalization rate.

This can also be done using the asking capitalization rates for properties posted in VP Market™ and other sources and the asking rents from third party data providers thereby comparing the subject property's asking capitalization rates and rents to the asking capitalization rates and rents of properties currently on the market. While the sale and rent comps provide the low end of the property's value, the asking prices and rents provide the upper end of the property's value.

The user's review of the table of Selling Prices/Values enables the user to identify the combinations of rental rate and capitalization rate to be used to produce the desired target value.

Once this is done the user moves forward to Valuation where the user completes a comprehensive valuation of the property along with a RePositioning™ Analysis if the property requires improvement in order to achieve the desired target value selected in Target Matrix™.

FIGS. 12 and 13 Qualification Phase—VP Profile™ depicts the screen where the user describes the property and its submarket. Information previously entered in the system will automatically populate the screen and will not have to be re-entered.

VP Profile™—
Identifies some of the data entry requirements associated with VP Profile™
Once preliminary data is entered in the VP Profile™ it is used during Target Matrix™ to search third party data basis for comparable lease and sale information.

FIG. 14 Qualification Phase—Sale & Lease Comps

Sale Comps—The screen provides a place where the user can initiate a search for sale comps and view sale comps brought into the system electronically or manually and determine the capitalization rate increment for the comparable sales to be used in Target Matrix™.

Lease Comps—The screen provides a place where the user can initiate a search for lease comps and view lease comps brought into the system electronically or manually and determine the rent increment for the comparable rents to be used in Target Matrix™.

FIG. 15 Qualification Phase—Target Matrix™—presents a typical Target Matrix™ screen that is produced by the decision support method of the present invention. Target Matrix™ uses comparable lease and sales information (rent per square foot and capitalization rates) now stored in the property's VP Profile™.

The system identifies the highest and lowest rents and capitalization rates being experienced in the property's submarket. This establishes a range for each which the user then increments. In the alternative the user can manually establish a range for rent and capitalization rates and increment it as shown in FIG. 14.

The user reviews the information calculated and presented in Target Matrix™ to identify:
The combinations of rent per square foot and capitalization rate required to produce the desired target Market Value/Selling Price
Once the user identifies the combinations of rents and capitalization rates that will produce the desired target Market Value/Selling Price, the user proceeds to identify the single combination that will cost the least to produce the desired target Market Value/Selling Price.

If improvements are required to produce the desired target value, the user proceeds to Valuation and on to complete a RePositioning™ Analysis.

FIG. 16 Property List, describes the properties that have been entered in VP CRE™. In addition, the user can Add A New Property, Select an existing property, go to the Valuations created for a listed property, or Delete a property.

FIG. 17 Valuation Phase—Property Detail & Buildings

Property Basics—is a screen used to enter information describing the property including the buildings that make up the property. Once the Property Detail is entered, the property is added to the Property List.

Buildings—If the property consists of more than one building, additional buildings can be described and added.

FIG. 18, VP Valuation Phase, depicts a flow chart/decision tree of the Valuation Phase of VP CRE™ and the sequence and order of its method steps, showing:
The categories and types of information entered into the system in order to solve for Calculated Selling Price/Value
Decisions regarding the need for a risk analysis (VP Score™) before deciding on a Sales/Offering Price
Deciding on a Sales/Offering Price
Optimizing the property's value using DealMaker™ and then sell; hold; trade; reposition; reposition and hold, or reposition and trade or sell. Where each alternative that involves continuing to hold can also involve financing or refinancing.
If a decision is made to trade, sell finance or refinance the property, the user can create an offering memorandum and or share a valuation with a party to the potential transaction.

FIG. 19 Valuation Phase—

Valuation List, presents the user with a list of the valuations that have been begun and or completed for a given property. Here a user can Enter A New Valuation, Select an existing valuation, Copy an existing valuation, or Delete a valuation. The Valuation List also identifies valuations that have been Shared.

Valuation Share Access: Provides the user with the ability to share a valuation with others. The user can copy a valuation and share it with edit rights with a potential buyer, who can, in turn, copy the shared valuation and then begin modifying the copy to arrive at their estimate of value. A potential buyer or lender will find a property of interest using VP Market™ where they can request access with edit rights and the person who posted the property to VP Market™ decides whether to grant the requested access. The person creating the valuation can also share the valuation with others without them asking for access through VP Market™.

Sharing access is accomplished by entering their email address and electing to give them viewing or edit rights. If given viewing rights, another party at a different location can view the Valuation and collaborate with the person creating it but cannot change it. With edit rights, the individual with whom the Valuation has been shared can edit the data entries and collaborate in real time with the creator of the Valuation. This allows people with a variety of skills and knowledge to collaborate in real time regardless of their location so long as they have internet access.

FIG. 20 Valuation Phase—

Valuation Detail This is a data entry screen where users make their initial selections regarding the type of valuation to be done. These selections include:
Valuation Description
Valuation Start Date
Valuation Period
   1 Year—Typically used for smaller properties. If a more comprehensive valuation is later needed it can be done by building on the 5 Year Valuation Period.
   5 Year—Typically used for smaller properties where the property's value shows a substantial increase in years 2-5. If a more comprehensive valuation is later needed it can be done by building on the 1 Year Valuation Period.
   10 Year—Used for larger and institutional grade properties particularly where discounted cash flow is used to value the property and the discounted cash flow's resulting IRR is used to compare this investment opportunity with other such opportunities.
   15 Year—Often used for standalone Triple Net (NNN) properties
   20 Year—Often used for standalone Triple Net (NNN) properties with long lease terms
Perform internal Rate of Return—Yes if comparing IRR with other investment opportunities is what is desired
Credit Loss
Expenses Details
   Estimated Expenses per Square Foot—Often combined with a 1 Year Valuation Period for smaller properties.
   Schedule of Expenses—Always used with properties with a 10 Year or longer Valuation Period unless the lease or leases are Absolute 100% Triple Net (NNN). Using a Schedule of Expenses creates a much more accurate estimate of value than estimating the expenses on a per square foot basis. Also employed when the user will included Internal Rate of Return as part of their valuation to compare and judge the quality of an investment.
   Absolute 100% Triple Net (NNN) Property Only used if the property is completely and totally Triple Net, i.e. the tenant pays absolutely all the operating expenses.

Sale—Here the user enters the Sale Capitalization Rate To assist the user in identifying the appropriate capitalization rate for the valuation, the user returns to Target Matrix and selects the optimal capitalization rate consistent with the rents reflected in the existing leases and those available in the market.

Resale—The user next enters the Going Out Capitalization Rate (the capitalization rate used to value the property at the end of the Valuation Period). This capitalization rate is typically higher than the Sale Capitalization Rate as the property will be older at that time and may have experienced economic obsolescence and or deferred maintenance during the Valuation Period. The user enters the Selling Expenses associated with a sale at the end of the Valuation Period. On the other hand, if the local economy around the property is expected to improve, the capitalization rate may be lower.

Capital Expenditures—Lastly, the user enters a percentage that is used to calculate Capital Reserves and the amounts of any planned lump sum capital expenditures during the Valuation Period.

FIG. 21 Valuation Phase—Expenses (Annual Dollar Amount Per Square Foot), As shown at the bottom of FIG. 21, Valuation Detail, the user can decide to handle Expenses in one of three ways:
Dollars per square foot—If selected the system will not calculate Reimbursed Expense Income:
A Detailed Schedule of Expenses—The system will calculate Reimbursed Expense Income
On an Absolute NNN Basis—By definition there are no expenses paid by the owner as the tenant pays all expenses

This is the screen where the information describing the Expenses on a Dollar per Square Foot basis is entered. A dollar per square foot amount or a lump sum amount is entered for Property Taxes along with the rate at which they will be increased over the Valuation Period and the system calculates the percent of the operating expense budget represented by Property Taxes. In the alternative, property taxes can be estimated as a percent of the selling price and the system will calculate their dollar amount.

The user then enters the total dollars per square foot for the other Operating Expenses and the system calculates the Percent of Budget and the Budgeted Amount for Year One. The user enters the amount of the Annual Increase and the system calculates the Operating Expenses for each year in the Valuation Period.

FIGS. 22 and 23 Valuation Phase—Expenses—Detailed Schedule, is the most accurate method of estimating expenses and is the step in the decision support process where the user enters amounts for each type of expense being incurred to operate the property. If the user decides to use a Detailed Schedule of Expenses, the user enters the amount and rate of increase for each expense type. The system then calculates the percent of budget, dollars per square foot, and the amount for each year in the Valuation Period. If the property is generating expenses that are not on the system's standard list, the user can create User Defined Expenses which will be added to the standard list. In addition, the user can enter property taxes as a percent of the selling price and the system will calculate a dollar amount for property taxes.

FIG. 24 Valuation Phase—Expenses—

Expense Audit, shows a link that takes the user to an Expense Audit screen.

Expense Audit, Expenses For Valuation Year 1—This presents the user with the ability to review the results of their expense entries and calculations for Year 1 of the Valuation Period. This ability to audit a set of entries immediately after they are made is unique to VP CRE™ and is essential to uncovering errors. Absent this ability, the errors go undetected and in the end distort the value of the property and the user's decision making process.

FIG. 25 Valuation Phase—Expense Audit, Expense Total By Valuation Year Here the user can review the total projected Operating Expenses and the total Operating Expenses per Square Foot for each year in the Valuation Period.

FIG. 26 Valuation Phase—Tenant List Once the basic information describing a tenant lease has been entered on the Rent Roll Detail Screen, the tenant's Building, Suite Number, Name, and Rentable Square Feet appear on the Tenant List where the user can Enter a New Tenant, access a tenant's Details Copy or delete a tenant lease.

FIG. 27 Valuation Phase—

Rent Roll Detail This is the point in the valuation phase where each tenant's name and the additional information describing the tenant's lease is entered. In addition to the more obvious information, lease terms regarding how expenses are allocated between the owner and the tenant are entered to:
Establish the Expense Stop for the Base Year if that is one of the lease terms;
Identify the amount of any expenses paid by the owner that are unique to the tenant occupying the suite
Identify if a sale of the property will affect the amount of the property taxes paid by the tenant as some leases contain a provision that the tenant is not to pay any prorated share of an increase in property taxes due to a sale of the property.

Rent Roll Detail—Expense Type,

The user employs this screen to define a tenant's lease as either basically Full Service or basically Triple Net (NNN). In a lease that is 100% Full Service, the Landlord pays all the expenses. In a lease that is 100% Triple Net (NNN) the tenant pays all the expenses. In many tenant leases the lease is neither 100% Full Service or 100% NNN, but is closer to being one than the other. In those cases the user describes the lease as either NNN or Full Service and proceeds modify the Full Service or NNN expense arrangement by clicking on the Modify NNN or Modify Full Service buttons. From there the user can add information on the two lines provided to describe the lease.

For example; In the case of a tenant whose lease is basically Full Service the user will click on the radio button entitled “Full Service” and then click on “Modify Full Service” In such a case the user may enter Plus Janitorial and Utilities if that is how the otherwise Full Service lease is modified. This would reflect a tenant lease where the landlord is paying all the expenses except janitorial and utility expenses.

If the Landlord were paying all expenses, the user would click on the radio button entitled “Full Service” and not go on to click Modify Full Service as the tenant has an unmodified Full Service lease.

Rent Escalation, provides the user the opportunity to define the rent escalations in the lease as an annual percentage or dollar amount each of which will take place on the lease anniversary date or to specify user defined escalation periods on FIG. 30.

Rent Abatement The user enters the number of months of free rent at the beginning of the lease or specifies user defined escalation periods on FIG. 31.

FIG. 28 Valuation Phase—Rent Roll Detail—Releasing Assumptions (RLAs) This continuation of the Rent Roll Detail screen provides a user with the ability to assign to the suite Releasing Assumptions which are used to estimate the financial impact of a lease expiration on the property's net operating income and cash flow. Here a user can Create A New Releasing Assumption (RLA) or Copy an existing one and modify it to create a new one. This is also the place where existing RLAs are listed and available to be copied and applied to other suites. The user will assign an RLA to each vacant suite in the property and to each suite where an existing lease expires before the end of the Valuation Period.

FIG. 29 Valuation Phase, Modify Full Service—This is where the user can check the boxes identifying the expense types that the tenant reimburses the owner for or pays directly to an outside vendor. Since the tenant in this example is paying outside vendors for Janitorial and Utilities, these boxes have been checked.

FIG. 30 Valuation Phase—Suite Rent Escalation—As an alternative to creating rent escalations that take place on lease anniversaries, the user can create a user defined rent escalation for increases that take place on other than lease anniversary dates for any year during the lease period.

FIG. 31 Valuation Phase—Suite Rent Abatement If free rent is offered at times other than at the beginning of the lease, or at times in addition to the beginning of the lease, the user accounts for these periods and their amounts using Suite Rent Abatement.

FIG. 32 Valuation Phase—Rent Roll Releasing Assumptions (RLA) List Once a Releasing Assumption is complete its name appears on a list of Releasing Assumptions where its associated Details can be viewed, Copied and applied to other suites or Deleted.

FIG. 33 Valuation Phase—Rent Roll—RLA Detail It is here that the user decides on the elements of each new Releasing Assumption. The user enters the information requested to describe the Releasing Assumptions for a suite or a group of suites. Here the user enters:

RLA Description

Lease Term

Rent Abatement

FIG. 33 Valuation Phase—Rent Roll—Valuation Phase—Rent Roll—RLA Detail continued

Market Rents Here the user enters:

Market Rent for a new Tenant

Market Rent for the existing tenant if they renew

Rent Escalations Here the user enters:

Percent increases on anniversary dates

Dollar increases on anniversary dates

Tenant Improvements Here the user enters the estimated Tenant Improvement Cost in $ per Sq. Ft. for a:

New Tenant

Renewing Tenant

Downtime/Renewal Probability Here the user enters:

The expected Downtime between tenants if the existing tenant does not renew.

The renewal probability for the existing tenant

Leasing Commissions Here the user enters:
The percent of the lease consideration to be paid in leasing commissions for a new tenant
The percent of the lease consideration to be paid for leasing commissions if the Existing Tenant Renews

FIG. 34 Valuation Phase—Rent Roll—Renew or Replace Renew or Replace supports the user's decision making process in negotiating lease renewals. Typically Renew or Replace can also be used as an App on a stand-alone basis by tenants and landlords, those representing tenants and landlords and those advising tenants and landlords. However, in the example shown in FIG. 34, the user has entered the data defining a Releasing Assumption (FIG. 33), the Renew or Replace feature is being used here to optimize the Releasing Assumptions for the various suites and floors of the building. The user enters data defining the elements of the Releasing Assumption for both cases—a tenant that will replace an existing tenant and a tenant that will renew their lease. These elements include:
Downtime between tenants when the suite is not occupied
Months of free rent to attract a new tenant or to renew an existing tenant
The cost of Tenant Improvements required in each case
The starting rent along with rent increases required to attract a new tenant or renew an existing tenant
The amount of leasing commissions in each case
The Discount Rate or Cost of Capital
The amount of any other owner concessions such as moving or cabling cost or other owner concessions required to attract a new tenant.

Once the above data is entered, the system calculates the net present value of the income stream produced by a tenant if they renew and the net present value of the income stream if a replacement tenant is found. The user can then compare the two net present values and decide on the optimal combination of releasing assumptions. This optimal combination may be the one that minimizes the up-front cost of renewal (tenant improvements, downtime, leasing commissions and other owner concessions) at the expense of achieving a higher initial rent and rent increases or vice versa. The user can also go to DealMaker™ and review the impact of RLA decisions on the value of the property and balance cash flow considerations with appreciation. Many of these decisions will be based on the owner's objectives as either a passive investor focused on cash flow or an entrepreneurial investor focused on the appreciation available from higher rents and larger rent increases even though the risk of downtime may be higher or an investor somewhere in the middle of the risk range. Whether passive or entrepreneurial an investor can use Renew or Replace in conjunction with Deal Maker to create or identify the most profitable time to sell based in part on key tenant lease expirations.

FIG. 35 Valuation Phase—Rent Roll—RLA Detail continued This screen is another portion of the RLA Detail screen allowing the user to determine what suites are assigned to this RLA. Clicking on the RLA Audit link takes the user to FIG. 36. Clicking on the Rent Roll Detail link takes the user to FIGS. 27-28. Clicking on the Rent Roll Summary link takes the user to FIG. 41.

FIG. 36 Valuation Phase—Rent Roll—RLA Audit This audit report shows the financial impact of the RLA on income as suites on the third floor are leased and leases on the third floor expire and are released. Releasing Assumptions impact a variety of income sources including Base Rental Income, Income loss due to Rent Abatement, Downtime between Tenants, and Expense Reimbursement Income. In addition they trigger Tenant Improvement Costs and Leasing Commissions both of which are paid for by the owner/investor. Users employ the audit report to identify and correct data entry errors that otherwise would go unnoticed and undermine good decision making.

FIG. 37 Valuation Phase—Rent Roll Audit—Menu and Rent Escalation Audit The top portion of this screen is the Rent Roll Audit menu. Clicking on the Rent Escalation Audit link takes the user to the Rent Escalation Audit for Suite #200 shown in FIG. 37 and described in the following paragraph.

FIG. 37 Valuation Phase—Rent Escalation Audit This audit report shows the lease rate increases and their impact over the Valuation Period for Suite #200. The audit report presents the user with the initial lease rate, its increases over the Valuation Period, the months the lease rate is in effect for each year, the net rentable square feet in the suite over the Valuation Period, and the income produced at each individual lease rate along with the total for the year. The numbers presented to the user in gray are a result of rent increases produced by a Releasing Assumption. Users employ the audit report to identify and correct data entry errors that otherwise go unnoticed.

FIG. 38 Valuation Phase Rent Roll Audit—Rent Abatement Clicking on the Rent Abatement link on the top of FIG. 37 takes the user to the Rent Abatement Audit Report described in the following paragraph.

Rent Abatement Audit The audit report shows that while the lease expires at the end of year 5 there is no rent abatement that applies to Suite #200. However, the user can also see the months of downtime expected between tenants. This is the product of an expected 6 months downtime between tenants and a 70% probability that the existing tenant will renew, hence 1.8 months of downtime. Users employ the audit report to identify and correct data entry errors that otherwise go unnoticed and distort future decision making.

FIG. 39 Valuation Phase—Rent Roll Audit—Expense Reimbursement Clicking on the Expense Reimbursement link in FIG. 37 takes the user to two audit reports—FIG. 39, Expense Reimbursement Suite #103 Year 1 and FIG. 40, Tenant Expense Reimbursement Summary.

Expense Reimbursement Suite #103, Year 1 The audit report shows the expense reimbursement for Suite #103, which has a Triple Net (NNN) lease. Because the tenant's lease is Triple Net (NNN), the tenant, by reimbursing the owner, is paying for all the expenses associated with occupying the suite. The audit report shows, on a net rentable square foot basis, the amount of each type of expense that is allocated to Suite #103 along with the size of the suite, the amount of the tenant expense to be reimbursed, and the rate of annual Increase by expense type Users employ the audit report and compare it to property management accounting records to identify and correct data entry errors that otherwise go unnoticed.

FIG. 40 Valuation Phase—Rent Roll Audit—Tenant Expense Reimbursement Summary, Suite #103 The audit report shows the projected expense reimbursement for Suite #103 for the Valuation Period plus one year. Since Suite 103 is leased on a NNN basis, there is no Expense Stop and this causes the Owner Paid Expenses per Sq. Ft. to equal the Expense Reimbursement per Sq. Ft. With exception of year 6 when the lease expires and Suite #103 encounters downtime, there are no un-reimbursed months. Users employ the audit report to identify and correct data entry errors that otherwise go unnoticed.

FIG. 41 Valuation Phase—Rent Roll Audit for Suite #103 Here the user can review the amounts produced by the entries that create Base Rental Income, lost income from Abatement and Downtime between tenants, Reimbursement Income and finally Rent Roll Audit Income—total income. Users employ the audit report to identify and correct data entry errors that otherwise go unnoticed.

FIG. 42 Valuation Phase—Other Income Here the user identifies and enters the sources and amounts of Other Income including User Defined Sources of Other Income. The system adds this to the Base Rental Income (Income from Suite Rental) and expense reimbursement income to arrive at Potential Gross Income/Gross Scheduled Income.

FIG. 43 Valuation Phase—Sale Price & Offering Price

Sale Price Calculation Based on using the Income Approach To Value At this point in the decision support process, the system produces an Operating Income Statement that includes Net Operating Income, the Sale Capitalization Rate, Selling Price, and Price per Sq. Ft. The Sale Capitalization Rate is taken from the user's entry in FIG. 20. Using previous entries, the system calculates a Selling Price and Value and Selling Price and Value/Sq. Ft.

Offering Sale Price—Here a user can use the information presented in FIG. 43 to decide on an Offering Price. A user can simply round the calculated Selling Price presented above in FIG. 43 or make whatever change they find desirable. After entering the desired target Offering Price, the system returns the Offering Cap Rate and Offering Price per Square Foot. From there the user can make changes to the Offering Price until they are satisfied the Offering Capitalization Rate and Offering Sale Price per Square Foot have been optimized.

FIG. 44 Valuation Phase—Structure the Financing, depicts a detail flow chart/decision tree illustrating the sequence and order of the method steps in structuring the financing. This includes entering the data describing any First and Second Loans to be placed on the property at which point the system calculates and presents the user with the resulting debt service, loan to value ratio, and debt coverage ratio. In addition, if the system calculations produce Pre-Tax Cash Flows below the break-even point, the system's Suspicious Items feature will alert the user and the user is then free to make changes to avoid that circumstance.

The information describing the loans is also saved and stored in VP Profile™ where it is available to be matched with the data entered by a lender. A more detailed description of the Structure the Financing method steps is provided in FIG. 45.

FIG. 45 Valuation Phase—Financing—Sale Price, First Loan, Second Loan, and Structure The Financing

Sale Price—As the user begins to define the structure of the financing they are presented with the calculated Selling Price and the Offering Price they decided on in FIG. 43.

First Loan—From there the user decides whether to move forward on an all cash basis, put a new first loan on the property or, in the case of a purchase transaction, possibly assume an existing loan. If a new loan is to be put on the property or an existing loan is to be assumed, its terms are described here along with debt service and debt coverage ratio created by the loan.

Second Loan—If a second loan is to be placed on the property the information describing it is entered here.

Structure the Financing This screen presents the user with the results of the decisions they made defining the financing of the property including any First and Second Loans. Here they view the resulting:

Total Loan to Value Ratio;

Total Debt Coverage Ratio;

Total Amount Being Financed;

Cash Flow resulting from their financing decisions; and

Cash on Cash Returns resulting from their financing decisions

From here a user can easily return and make changes to the First and Second Loans and then quickly return here see the results and continue to make changes until the structure of the financing produces the desired results. When these method steps are complete the user moves forward to DealMaker™.

FIG. 46 Valuation Phase—DealMaker™ depicts a detailed flow chart/decision tree of the DealMaker™ method illustrating the sequence and order of the method steps, showing the input entries made defining the value of the factors that drive a property's value in the order they have the ability to impact the property's value, and providing the ability to access and change any one or all of these values from this single point in order to optimize the underlying financial assumptions and with those the value of the property.

FIG. 47 Valuation Phase—DealMaker™—Valuation Summary Having entered the required data to this point, the user can now begin making decisions that will optimize the value of the property and prepare the user to effectively negotiate to maximize their return on investment in selling, purchasing, financing, refinancing, appraising, or assessing the property.

DealMaker™ provides the user with the ability to optimize the value of the property. This is done by optimizing the values associated with the individual factors that drive the value of the property. VP CRE™ presents these factors to the user in the order they have the ability to impact the property's value. To begin, the user reviews the Valuation Summary where the following information is provided for each year in the Valuation Period.

Net Operating Income

Value

Value/Square Foot

Cash Flow

Cash on Cash Return

FIG. 48 Valuation Phase—DealMaker™—Sale Capitalization Rate, Financing, & Releasing Assumptions

Sale Capitalization Rate—The first and most powerful influence on the value of a property is the capitalization rate used to value it. Here the user can review the Sale Comps entered or brought into the system as part of Target Matrix™ during the Qualification Phase and decide on the optimal capitalization rate. If the user wants to change the existing Capitalization Rate, they simply click on the link entitled “Sale Capitalization Rate” make the change and they will be returned to this screen. From here the user can view the impact of their changes by reviewing the measures of value in the Valuation Summary.

Financing—Financing a property provides financial leverage and that is typically the second most powerful influence on a value. If the user decides to make changes to the financing it is done here by clicking on “Financing,’ making the desired changes and returning here to view the impact of the changes by reviewing the Valuation Summary.

Releasing Assumptions—This Screen presents the user with the Releasing Assumptions (RLAs) in the order that they can impact the value of the property; for example percent of the net rentable square feet or net operating income. The fact the percent of property is 0 in the early years reflects the fact that an RLA is not applied until an existing lease expires. The user clicks on a link describing an RLA, makes their desired changes, and then returns to DealMaker™ to view the impact of the changes in the Valuation Summary. Here again this step in the method can be repeated until the user is satisfied that they have exhausted their ability to optimized the value of the property by modifying the Releasing Assumptions (RLAs).

FIG. 49 Valuation Phase—DealMaker™—Other Income, Credit Loss, & Going Out Capitalization Rate

Other Income—The Screen presents the user with the sources and amounts of Other Income. These can be changed and the impact of changes can be viewed on the Valuation Summary in DealMaker™.

Credit Loss FIG. 49 presents the user with the ability to make changes to Credit Loss. The user can make changes directly and then return to the Valuation Summary and view the impact of the changes.

Going Out Capitalization Rate If the user wants to change the existing Going Out Capitalization Rate, they do so by clicking on the link of the same name, making the change and returning to DealMaker™ to view the impact of the change in Valuation Summary. Both the passive and entrepreneurial investors can also use DealMaker™ to identify the most profitable time to sell.

FIG. 50 Valuation Phase Internal Rate of Return (IRR)—Pre-tax Cash Flows Residual

Pretax Cash Flows—If the user has elected to employ Internal Rate of Return to judge the potential return on investment available from the property, they are first presented with screens showing the Pre-tax Cash Flows and Pre-tax Cash on Cash Returns for each year in the Valuation Period. These are arrived at by subtracting the cost of Tenant Improvements, Leasing Commissions, Furniture Fixtures, and Equipment, Capital Reserves, and Lump Sum Capital Expenditures from the property's Operating Cash Flow. Here again the user can make changes until they are satisfied with the Pre-Tax Cash Flows and Pre-Tax Cash on Cash Returns. These capital expenditures and their timing can have a significant impact on a property's IRR. When they are satisfied with their entries, they move forward to Residual where they see the net proceeds of sale when the property is sold at the end of the valuation period.

Residual The residual is the amount of funds remaining after the property is sold at the end of the Valuation Period when any existing loans are paid off and the selling expenses are paid. The Residual Screen provides the user with the ability to modify the Going Out Capitalization Rate to see the impact on the Net Proceeds from Sale.

FIG. 51 Valuation Phase—IRR & Offering Sale Price—The user enters a range of IRRs within which the system of the present invention supports the user in deciding on the Offering Price based upon IRR as opposed to Offering Price based upon capitalization rate. With the incremented range entered, a matrix is produced showing the Price per Square Foot, Sale Price, Capitalization Rate, First Loan To Value Ratio and the Cash on Cash Return for each incremental change in the IRR. At this point the user is looking for the Offering Price in the column entitled “Sale Price.” From there the user can identify the IRR associated with the Offering Price, and the other measures of value defined by the column headings.

Offering Sale Price Here the user can make changes to the Offering Sale Price and see the impact on the Offering Cap Rate, Leveraged IRR, and Un-leveraged IRR. Here again the user is able to optimize value by refining their selection of the Offering Sales Price and Market Value consistent with corresponding IRRs and other measures of value shown in the matrix. In this manner the user balances Price per Sq. Ft., Cap Rate, First Loan To Value Ratio, and IRR (both leveraged and un-leveraged) thereby optimizing the value of the property and preparing themselves to defend their decisions during the Marketing and Negotiation Phases.

FIG. 52 VP Profile™ and the VP Score™ Portion of VP Profile™ depicts a detailed flow chart/decision tree of that portion of VP Profile™ termed VP Score™ that illustrates the sequence and order of the method steps used to score the quality of the property as it relates to:

Property Score™
Compare Price & Price per Square Foot with others in the same submarket
Score the property's ability to fund capital expenditures and still produce positive pre-tax cash flows (Please see FIGS. 73 and 74)
Score the property's ability to profitably release suites as existing tenant leases expire. What will be the amount of:
   Downtime between tenants
   Rent abatement
   Tenant Improvements paid by the owner.
   Other lease incentives to attract replacement tenants
The IRR for the Valuation Period.
Property data including the term of selected leases
Existing lease rental rates
Tenant turnover—The percent of existing tenants who renew
The percent of the premises occupied by tenants with credit ratings above a user specified amount

Market Score™:
Market data including market lease rates
Market releasing time
The rate at which space is being absorbed in the property's markets—the property's submarket and neighboring submarkets in which the property competes for tenants
Space absorption in the property's markets
Building permits being processed for new construction in the property's markets
The vacancy rate for the property
The vacancy rate for the market

Economic Score™:
Tenant Credit Ratings
The tenant's industry rating
Leading economic indicators
   In the property's markets
   In the property's state
   In the nation
Crime statistics in the property's markets

VP Credit Score™:
Owner/Buyer's credit rating
The amount of planned operating reserves.
The percent of the space occupied by credit tenants

Owners, lenders, and prospective buyers can weigh the above items based on their needs and then score the Property, Market, Economy, and the property's Credit worthiness.

Once the above items are accomplished, the system scores the properties income stream as ranging from best suited for:
The passive investor, or
The entrepreneurial investor
To those in between.

Developing and Deciding On Alternatives Phase A property owner has many alternatives available to them including by not limited to the following:
Develop raw land and hold the improved property
Sell the raw land
Sell the property with additional undeveloped land
Sell improved property
Continue to hold it
Continue to hold it and sell at a later more advantageous time
   At a time when the economy is peaking
   At a time when the property's measures of value are peaking
Continue to hold it and trade it for another property at a later more advantageous time
Continue to hold the property and improve it—reposition it in its submarket, at a future time.
Trade it for another property
Reposition the property and hold it
Reposition the property and sell it
Reposition the property and trade it

By reviewing the Valuation Summary in DealMaker™ and employing the RePositioning™ and TradeUp™ analysis, an owner can model and view various courses of action or combinations of courses of action to evaluate their potential and identify and decide on the optimal one.

Other parties, such as potential buyers and lenders, can use these same method steps to evaluate the reasonableness of the underlying assumptions used by an owner and the owner's conclusions regarding the overall value of the property. These parties can do this for each of the alternatives that owner has modeled for their benefit or for alternatives the owner has not yet considered.

FIG. 53 Developing and Deciding on Alternatives—RePositioning™ Analysis, depicts a detailed flow chart/decision tree illustrating the sequence and order of the method steps used to evaluate the feasibility and desirability of repositioning the property to command higher rents and a lower capitalization rate.

The user enters data that establishes a Proforma Annual Income & Expense Statement. The data entries reflect values associated with the expected economic performance of the property after repositioning and include:

Net Rentable Square Feet

Rent per Net Rentable Square Feet

Parking Income

Miscellaneous Income

Expense Reimbursement Income

Credit and Vacancy Losses

Property Taxes

Operating Expenses

The Financing required to fund the repositioning
Interest Rate
Amortization Period
Balance Due Date

From the data entries the system calculates and displays the repositioning summary where the property's current economic performance is compared with the Pro form a for the projected economic performance after repositioning. Developer ScratchPad™ can be used to estimate the cost of the planned improvements.

FIG. 54 Developing and Deciding on Alternatives—RePositioning™ Analysis—RePositioning™ Proforma, RePositioning™ Financing, Existing Debt Equity Structure, and New First Loan

Proforma Annual Income & Expenses—Here the user describes the desired economic performance of the property after the property has been improved and repositioned in its submarket. Once the data is entered the Net Operating Income is calculated and displayed to the user.

The estimated cost of improving the property and thereby repositioning the property to command higher rents and a lower capitalization rate can be estimated using Developer ScratchPad™ shown in FIGS. 5 and 6. From there the user can return to the RePositioning™ Analysis.

RePostioning™ Financing—This Figure describes the portion of the new financing, $500,000, that will be used to fund the repositioning the property. In addition the owners will contribute $150,000 of New Investment. The owners added investment of $150,000 along with $500,000 in refinancing proceeds, or a total of $650,000, will be spent to reposition (upgrade) the property. The owners also plan to take $350,000 out of the property by way of the refinancing which is identified as Net Proceeds of Refinancing.

Existing Debt Equity Structure—Shows the property's Existing Debt & Equity Structure to assist in deciding on the source and amount of funds for use in repositioning the property.

New First Loan—Here the user is presented with the amount to be financed with a new loan and then moves forward to enter the Interest Rate, Amortization Period, and the Balance Due Date for the new financing. Upon entering that data, the system calculates and displays the amount of the Annual Debt Service, the Loan To Value Ratio for the new first loan, and the Debt Coverage Ratio for the new first loan.

FIG. 55 Developing and Deciding on Alternatives—RePositioning™ Summary Once the user enters the data required in FIG. 54 the system calculates and presents the Repositioning™ Summary allowing the user to compare the property's existing financial performance with that expected after improving the property. From here the user can make changes to any of the data the user entered (including that entered into Developer ScratchPad™ to estimate the cost of upgrading the property) to arrive at the target values displayed in RePositioning™ Summary. Using the RePositioning™ Summary the user can decide on the improvements to be made, their cost, feasibility, and the overall feasibility and desirability of repositioning the property within its submarket.

FIG. 56 Developing and Deciding on Alternatives—TradeUp™ depicts a flow chart/decision tree illustrating the sequence and order of the method steps involved in evaluating the feasibility and desirability of entering into a tax deferred exchange pursuant to Section 1031 of the Internal Revenue Code.

The first step is to define the economic performance of the Target Property—the property that the owner of the current property will own after the trade. This is done by entering the following information associated with the Target Property:

The size in Net Rentable Square Feet

Rent per Net Rentable Square Feet

Other Income

Lost Income due to Credit and Vacancy

Property Taxes

Operating Expenses

Capitalization Rate

Projected rate of Increases for Rent & Other Income

Projected rate of Increases for Property Taxes

Projected rate of Increases for Operating Expenses

Additional Investment

The Interest Rate for the loan on the Target Property

The Amortization Period for the New Loan

The date the loan is due on

The system uses the above data and calculates the:

Down Payment for the Target Property

Loan Amount

Annual Debt Service

Loan to Value Ratio

Debt Coverage Ratio

Total Debt Service

Operating Cash Flow

Operating Cash on Cash Return

The system uses the results of the above calculations to produce a summary of the changes in Operating Cash Flow, Market Value, and Equity for each year in the Valuation Period. The user can review these projected changes and go back and modify the entries defining the Target Property's financial performance to improve the projected changes until the user is satisfied with the results.

Once the user decides the changes in these projected measures of value warrant executing the trade, the user can use VP Market™ to sell the existing property and identify one that meets his TradeUp™ requirements. FIGS. 57 to 58 describes the TradeUp™ method steps in more detail.

FIG. 57 Developing and Deciding on Alternatives—TradeUp™ Analysis—TradeUp™ Proforma, Capitalization Rate & Annual Increases, & New First Loan

TradeUp™ Proforma—The TradeUp™ Proforma is a data entry screen where the user defines the desired economic performance of the target property—the as yet un-named property that the user will trade into if such a property can be found. Once the user enters the required data the system produces the estimated Net Operating Income for the Target Property.

Capitalization Rate and Annual Increases Here the user enters the Capitalization Rate, the rate of increase associated with Rental Income, Other Income, Property Taxes, and Other Expense Categories that are associated with the desired Target Property.

New First Loan Here the user can see the Sale Price of the Target Property and the Net Proceeds of Sale from the existing property all or part of which will be used as the down payment to acquire the Target Property. The user can enter any amount of additional investment desired or required along with the data describing a new loan for the Target Property.

FIG. 58 Developing and Deciding on Alternatives—TradeUp™, the TradeUp™ Performance Screen. This screen begins with the increase in Sale Price/Value and the Increase in Debt. This is presented to ensure that the user knows that the trade will result in an increase in both value and debt as these are required to qualify for a completely tax deferred exchange under Section 1031 of the Internal Revenue Code.

The next section of FIG. 58 presents the user with the expected changes in financial performance if the trade is executed. The changes are projected for each year in the Valuation Period and include:

Operating Cash Flow

Market Value

Equity

To the extent the expected changes in financial performance do not meet the user's requirements, the user can make changes to the economic criteria defining the Target Property or its financing to arrive at changes that are acceptable.

Timing

The question of what alternative or combination of alternatives to pursue generally carries with it the added question of timing. Should a particular alternative or combination of alternatives be executed now or at some future time? If a combination is to be executed should they be done at the same time or are there advantages to executing them at different times? Given the behavior of business cycle, markets and financing, these questions of timing can determine the success or failure of a planned action. The user can minimize this risk by reviewing FIG. 47, the Valuation Summary included in DealMaker™ to identify the best time in the Valuation Period to execute an alternative or combination of alternatives.

FIG. 59 Market Phase—VP Package™ depicts a detailed flow chart/decision tree for VP Package™ and illustrates the method steps of the present invention used to create and publish an offering memorandum—marketing package. Here the user decides on the individual reports that will be assembled to create an offering memorandum—the sale, financing, and refinancing, appraisal, or assessment package. When the offering memorandum is complete, it can be published to VP Market™ or as a pdf file, or in different formats or to different services.

FIG. 60 Market Phase—VP Package™—Package List Depending on the purpose of the valuation, the user can Create a New Package, view the Details associated with an existing Package, Copy an existing Package, or Delete a package.

FIG. 61 Market Phase—VP Package™ Package Detail If the user in viewing the screen entitled “Package List” desires to create a new package, they click on: Create New Package and are taken to FIG. 61. Here the user describes and names the package they are about to create and identifies the reports that want to include in the package/offering memorandum.

FIG. 62 Marketing Phase—Package Options—Broker List on the front page & Picture on the Front Page By clicking the box to the left of “Front Page” on FIG. 61 and clicking on “Create” the user can create a Front Page for the Offering Memorandum. Next the user is taken to the “Broker List on the Front Page” and “Picture on the Front Page” on this FIG. 62 where the people to be contacted can be identified along with their contact information. Also it is here where a picture of the property can be selected, a Caption can be entered and the picture and the Caption attached to the Front Page.

FIG. 63 Marketing Phase—Package Options—Executive Summary By checking the box “Executive Summary” on FIG. 61 and clicking on Create the user is taken to the Executive Summary shown in FIG. 63 where the user supplements the information already stored in the system to complete the Executive Summary. The information already in the system pre-populates the text boxes.

FIGS. 64 & 65 Marketing Phase—Package Options—Property Description By checking the box “Property Description” on FIG. 61 and clicking on Create the user is taken to the Property Description shown in FIGS. 64 and 65 where the user supplements the information already in the system to complete the description. The information already in the system pre-populates the text boxes.

FIG. 66 Marketing Phase—Package Options—Lease Comp List Here the user can view a list of the existing Lease Comps, Enter New Lease Comp, view the Details of an existing Lease Comp, or Delete a Lease Comp. They can also check a box to select the Lease Comps they want to include in the Offering Memorandum.

FIG. 67 Marketing Phase—Package Options—Lease Comp—Lease Comp Detail If the user clicked on “Enter New Lease Comp in FIG. 66 they were taken here where they enter information describing a new Lease Comp.

FIG. 68 Marketing Phase—Package Options—Sale Comp List Here the user can view a list of the existing Sale Comps, Enter New Sale Comp, view the Details of an existing Sale Comp, or Delete a Sale Comp. They can also check a box to select the Sale Comps they want to include in the Offering Memorandum.

FIG. 69 Marketing Phase—Package Options—Sale Comp Detail

If the user clicked on “Enter New Sale Comp” in FIG. 68 they were taken here where they enter information describing a new Lease Comp.

FIG. 70 Marketing Phase—Package Options, Create Package File In a similar manner reports presenting relevant information can be included by checking on any one of the remaining boxes and supplementing the existing information. This includes:
Bringing in maps showing the location of the property, Sale Comps, Lease Comps, demographic information or other relevant market data
Site and Floor Plans
The Schedule of Assumptions—these are the assumptions used in valuing the property
A Detailed Schedule of Expenses for Year One in the Valuation Period
Rent Roll
Leveraged Cash Flows for each year in the Valuation Period
Leveraged Cash Analysis
The IRR for the Valuation Period
A Summary Schedule of RLAs showing the detail for each
A Schedule of Capital Expenditures not reserved for
If completed, A RePositioning™ Analysis
If completed, A TradeUp™ Analysis

After the user has identified and completed any of the above, the user checks the box entitled “Create Package File” and the system creates an offering memorandum using the selected reports.

FIG. 71 Marketing Phase—VP Market™ depicts a flow chart/decision tree illustrating the sequence and order of the method steps involved in introducing the property to prospective buyers and or lenders by ranking and matching the related VP Profiles™ including but not limited to the properties offered for sale, buyers, sellers, developers, appraisers, and assessors.

Once an offering memorandum has been created along with the property's profile within VP Profile™, the owner posts the offering memorandum on VP Market™ a public website where potential buyers and lenders can match their profile with that of the property. In addition, potential buyers and lenders along with others, who would like access to the valuation underlying the offering memorandum, can request viewing or editing rights. Those receiving edit rights can make changes directly in the shared valuation or make a copy of the valuation to make changes so that they can arrive at their own estimated value for the property. Persons other than potential buyers and lenders who are capable of contributing to the creation of a valuation can use also use VP Market™ to view or edit the valuation.

In addition, a buyer or lender that has completed a VP Profile™ can use the system's Notify Me™ feature to request the system to notify them when properties matching their profile are posted on VP Market™.

VP Profile™—VP Profile™ allows the system to gather information and scoring to be stored to allow searching, matching, and ranking within the VP Market™ phase. Here the owner completes their profile of the property. When the owner completed the Valuation Phase, the system completed the VP Profile™ and VP Score™.

This included classifying the income stream as either passive or entrepreneurial. In either case the system rates the income stream on a scale from passive to entrepreneurial.

VP Profile™ for a Lender—A lender searching potential properties to lend on would complete their VP Profile™ including describing the property type they prefer to lend on and identifying their tolerance for risk—the class of income stream they prefer to lend on including their preferred range of scores for their chosen class. A lender might enter “Passive” and 7-10 as their preferred lending targets.

VP Profile™ for a Buyer—A buyer searching potential properties to purchase would complete their VP Profile™ to describe the property type they prefer and their tolerance for risk—the class of income stream they prefer to own along with their preferred range of scores. As an example; a potential buyer may enter the entrepreneurial range they desire.

By matching profiles owners interested in selling can find a buyer, a buyer interested in purchasing can located a desirable property, both owners and buyers can identify a likely lender, and a lender can find likely properties to loan on. Once a match takes place, the buyer or lender executes a non-disclosure agreement whose primary purpose is to protect the information contained in the Rent Roll section of the Offering Memorandum. From there a property owner can Share Access to a “live” Offering Memorandum. Once an owner Shares Access to a live Offering Memorandum, the recipient can copy and save the original. The recipient, using the copy, then makes changes to the underlying assumptions that drive value to arrive at their position on value. In this manner, the recipient is also preparing for their role in the upcoming value negotiation.

A potential buyer or lender can complete their profile and then ask the system to use the Notify Me™ to notify them when matches occur.

FIG. 72 Negotiation & Closing Phase depicts a flow chart/decision tree of the Negotiation & Closing Phase of VP CRE™ illustrating the sequence and order of the method steps, showing the method of negotiating as traditional or via an integrated messaging system. If successful the parties execute the documents and take the other actions required to close the transaction.

If the parties reach an impasse or encounter serious difficulty in reaching agreement it is generally because the assumptions underlying their respective valuations reflect significant differences. If so they can compare their assumptions using BaseLine™ which identifies and presents the parties underlying assumptions in a manner that makes it easy to compare them. Here the parties are engaging in a transparent exercise in due diligence/fact-finding to see specifically where they differ and by how much. This facilitates problem solving and deal making.

FIG. 73 Bargain To Your Goal™ Bargain To Your Goal™ is available to assist a party in crafting offers and counter offers so as to advance their interests during the bargaining phase where the final economics of the transaction will be decided and settled on.

Initial Bargaining Pattern

The user in FIG. 73 is a Buyer bargaining with a Seller who has made the initial offer—$15,000,000 (here the Seller established the asking price of $15,000,000 for the property). The Buyer responds by first setting $12,500,000 as their goal, their desired expected outcome of the negotiation. The Buyer then counters the Seller's asking price by entering a counter offer of $10,000,000—an amount that is as far from their goal as the Seller's asking price is —$10,000,000=$15,000,000−(($15,000,000−$12,500,000)×2). This creates an opening offer from the Buyer that is halfway in between the Seller's asking price and the Buyer's initial counter offer.

In the example shown in FIG. 73 if the Seller then counters the Buyer at $14,250,000 and at this point the Buyer can enter a percentage that will be applied to reduce the amount of the Seller's concession of $750,000 ($15,000,000−$14,250,000) to arrive at the Buyer's next calculated/suggested counter offer. In FIG. 73 the Buyer entered 30% in the text box and by doing so produced a counter offer amount of $10,525,000 which was arrived at by reducing the Seller's concession of $750,000 by 30% and adding that amount, $525,000, to the $10,000,000 that the Buyer initially counter at.

Subsequent Bargaining Pattern

Once the Buyer enters his second counter offer, be it $10,750,000 or 10,525,000 the system performs a trend analysis and predicts, given the rate at which each party is changing the amount of the concessions, the Expected Outcome. In FIG. 73, the Buyer entered $10,525,000 and this reduced the Expected Outcome from $12,500,000 to $12,224,416.

If in response to the Buyer making a $525,000 concession, the Seller's next offer is $13,750,000 the Buyer will have to offer the Calculated amount of $10,906,504 to maintain the Expected Outcome at $12,224,416. The system notifies the Buyer that their counter offer of $10,525,000 and the Seller's response of $13,750,000 is moving the parties into a phase of hard bargaining and may require the parties to return to Fact-finding before bargaining further.

If the Buyer wants to stay on track, maintain the trend toward $12,224,416, he will have to counter at no more than $10,906,504—a concession of $381,504. If he counters higher the Expected Outcome will increase in the Seller's favor.

At the same time the system is calculating (suggesting counter offers that will maintain the Expected Outcome) the system is also projecting the number of exchanges required to reach agreement. This is very helpful as some negotiators only have the patience for a certain number of exchanges before they abandon a negotiation and pursue other alternatives.

FIG. 74 Post Closing Phase Once the transaction that was the subject of the negotiation closes an owner who traded, placed financing on a property, an owner who repositioned a property, or a buyer who purchased a property, can make a live copy of the valuation reflecting the results of the negotiation and make changes to it as decisions regarding new leases or other actions are taken and use BaseLine™ to identify the impact of proposed changes and their financial impact on the property. This feature enables the user to easily compare the post-closing decisions with those that were projected when they decided to trade, refinance, reposition, or purchase the property.

The system and method for optimizing return on investment in real property as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a system and method for optimizing return on investment in real property in accordance with the spirit of the invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A computer-implemented web-based system for optimizing return on investment in real property comprising:
a) a qualifying phase software module stored within a computer memory and capable of accepting user data input and generating data output visually on display screens;
b) a valuation phase software module stored within a computer memory and capable of accepting user data input and generating data output visually on display screens;
c) a developing and deciding on alternatives phase software module stored within a computer memory and capable of accepting user data input and generating data output visually on display screens;
d) a marketing phase software module stored within a computer memory and capable of accepting user data input and generating data output visually on display screens;
e) a negotiation and closing phase software module stored within a computer memory and capable of accepting user data input and generating data output visually on display screens; and
f) a post-closing phase software module stored within a computer memory and capable of accepting user data input and generating data output visually on display screens;
whereby the system guides the user in ordering and executing the calculations within each of the six major phase modules by employing a unified decision support system that provides those transacting business in the real estate market a means of optimizing their return on investment by reducing transaction cost, time, uncertainty, and risk.

2. The computer-implemented web based system for optimizing return on investment in real property according to claim 1, wherein said qualifying phase software module stored within a computer memory and capable of accepting user data input and generating data output visually on display screens further includes a system to:
(a) derive the Weighted Average Net Effective Rental Rate that produces the user's target value using the Income Approach to Value; and
(b) derive a range of property values that include the user's target value by varying the amount of the capitalization rate and rental rate while holding the amounts for the remaining elements of the Income Approach to Value constant;
whereby the system generates a matrix of property values using the Income Approach to Value by varying the rental rate and the capitalization rate to guide the user in deriving the property's current value and the user's target value for comparison with the property's market value to determine the feasibility/advisability of moving forward with the next phase, namely, the valuation phase.

3. The computer-implemented web based system for optimizing return on investment in real property according to claim 2, wherein said qualifying phase software module stored within a computer memory and capable of accepting user data input and generating data output visually on display screens further includes a system to:
(a) derive the occupancy cost and ranked amenities for a specific lease by deriving Net Effective Rent for the period of the lease and the average Yearly Net Effective Rental Rate for the period of the lease using Rental Increases that are defined by a period of months rather than lease anniversary dates and are calculated by entering a percentage increase and a new rental rate with other being calculated and displayed, and Rent Abatement by a percent of specific months rather than beginning abatement periods on lease anniversary dates and calculating abatement in whole months;
(b) calculate Total Net Effective Occupancy Cost for the Lease and the Net Present Value of the Net Effective Occupancy Cost for the lease period using Parking by type and cost per type for year one of the lease and then escalating year one over the period of the lease by a user entered percentage, and Tenant Improvement and Miscellaneous costs escalated over the period of the lease by a user entered percentage; and
(c) derive an amenity score by multiplying user entered number reflecting the importance of that amenity by a user entered number rating the quality of the amenity;
whereby the system displays the results of the calculations described in (a), (b), and (c) above for comparison with but not limited to the user's target lease requirements,
the terms associated with competitive space that is being marketed for lease, and the property's Releasing Assumptions.

4. The computer-implemented web based system for optimizing return on investment in real property according to claim 1, wherein said valuation phase software module stored within a computer memory and capable of accepting user data input and generating data output visually on display screens further includes a system to:
(a) derive tenant reimbursed expense amounts;
(b) derive the amount of the increase in property taxes to be paid by a new owner when specific leases put the burden of such increases on the owner;
(c) derive the amount for a property expense type when the owner has agreed to pay for that property expense type in the tenant's lease; and
(d) generate audit reports;
whereby the system using user audited occupancy income and expense data calculates the Net Operating Income for the Property thereby increasing the user's confidence and understanding of the accuracy of the calculations and how the property value is determined using the income approach to value.

5. The computer-implemented web based system for optimizing return on investment in real property according to claim 4, wherein said valuation phase software module stored within a computer memory and capable of accepting user data input and generating data output visually on display screens further includes a system to:
(a) derive the structure of the target financing by deriving the type, amount, interest rate, and term of the first loan, debt service, and debt coverage ratio: deriving the type, amount, interest rate, loan term and annual debt service of a second loan; and deriving the down payment, total loan to value ratio, total debt coverage ratio, cash flow by valuation year and cash on cash return by valuation year;
whereby the system derives the terms of the financing for comparison with the terms available in the lending market to guide the user in developing the target financing.

6. The computer-implemented web based system for optimizing return on investment in real property according to claim 1, wherein said valuation phase software module stored within a computer memory and capable of accepting user data input and generating data output visually on display screens further includes a system to:
(a) calculate by Valuation Year the property's Net Operating Income, Value, Value per Square Foot, Cash Flow, and Cash on Cash Return; and
(b) generate a dash board wherein a user can change the Offering Sale Price and Credit Loss Percentage and navigate from the dash board by way of links directly to Sale Capitalization Rate, Financing, Releasing Assumptions ordered by the Percentage of the property's square footage they address/cover, Other Income, and the Going Out Capitalization Rate;
whereby the system displays a Valuation Summary by Valuation Year and the factors that affect value in the order they affect value—Specifically the Sale Capitalization Rate, Financing, Releasing Assumptions ordered by the Percentage of the property's square footage they address/cover, Other Income, and the Going Out Capitalization Rate to guide the user in selecting the factors to adjust and the amount to adjust them by in order to maximize the measures of return on investment set forth in (a).

7. The computer-implemented web based system for optimizing return on investment in real property according to claim 1, wherein said valuation phase software module stored within a computer memory and capable of accepting user data input and generating data output visually on display screens further includes a system to:
(a) use discounted cash flows and Internal Rate of Return to value a property and includes deriving Pre-Tax Cash Flows by Valuation Year by employing data for Operating Cash Flow, Tenant Improvements, Leasing Commissions, Furniture, Fixtures & Equipment, Capital Reserves, The Amount Lump Sum Planned Capital improvements, Pre-Tax Cash Flows, Pre-Tax Cash on Cash Returns, and Net Proceeds from Sale at the end of the valuation period;
(b) provide a dash board wherein a user can change the amount and Valuation Year for Lump Sum Capital Improvements;
(c) derive a range of property values using discounted cash flows to value the property wherein the range of property values is calculated using a range of incremented Internal Rates of Return; and
(d) provide a dash board wherein a user can change the Offering Sale Price and the system calculates the Offering Capitalization Rate, Leveraged Internal Rate of Return (IRR), and the Unleveraged Internal Rate of Return;
whereby the system displays a dash board including the measures of value set forth in (a) and a matrix of values showing by Internal Rate of Return the values for Price per Square Foot, Sale Price, Capitalization Rate, First Loan to Value Ratio, and Cash on Cash Return to guide the user in selecting and modifying the amounts for the measures set forth in (a) that will be discounted to arrive at the range of Internal Rates of Return displayed in the matrix which further guides the user in deciding on an Offering Sale Price with is associated Price per Square Foot, Capitalization Rate, First Loan To Value Ratio, and Cash on Cash Return which Offering Sale Price is entered and the system uses to calculate and display the Offering Capitalization Rate, Leveraged Internal Rate of Return and the Unleveraged Internal Rate of Return.

8. The computer-implemented web based system for optimizing return on investment in real property according to claim 1, wherein said developing and deciding on alternatives phase software module stored within a computer memory and capable of accepting user data input and generating data output visually on display screens, further includes a system to:
(a) derive a pro form a using the income approach to value that includes debt service, loan to value ratio, debt coverage ratio, Operating Cash Flow, Equity, Operating Cash on Cash Returns, Capitalization Rate, Selling Price, and Price per Square Foot for a property whose occupancy income and expenses have been improved as the result of physical improvements so the results of the improvements can be compared with the property's current financial performance measured using the same criteria; and
(b) use the Income Approach to Value including financing and increases in rent, other income, property taxes and other expenses to derive the financial performance of a target property over a projected holding period for comparison with financial performance of the property to be traded where the system calculates the projected changes in Operating Cash Flow, Market Value and Equity for the target property's projected holding period if it is acquired pursuant to a Section 1031 Tax Deferred Exchange;
whereby the system displays the comparisons to guide the user in maximizing their return on investment when deciding to improve a property and trade a property.

9. The computer-implemented web based system for optimizing return on investment in real property according to claim 1, wherein said post-closing phase software module stored within a computer memory and capable of accepting user data input and generating data output visually on display screens, further includes a system to:
(a) derive a comparison of the cost and income associated with renewing a tenant whose lease is expiring versus replacing such a tenant, where the system derives the cost of replacing a tenant and renewing a tenant using:
(i) the downtime in months for replacing and renewing a tenant;
(ii) the rentable square feet in the space with the expiring lease;
(iii) the rent per square foot to be charged to a new tenant and a renewing tenant;
(iv) the Tenant Improvement Cost to be incurred for a replacement tenant and a renewing tenant;
(v) the cost for leasing commissions for a replacement tenant and a renewing tenant; and
(vi) the discount rate to be used to derive the net present value associated with replacing a tenant and the net present value associated with renewing a tenant;
whereby the system displays the cost, income and net present value of replacing and renewing a tenant thereby guiding the user in their decision making process as leases are about to expire.

10. The computer-implemented web based system for optimizing return on investment in real property according to claim 1, wherein said marketing phase software module stored within a computer memory and capable of accepting user data input and generating data output visually on display screens, further includes a system to:
(a) define properties that are similar according to a property profile employing data on property type including Office, Research and Development, Industrial, Warehouse, Flex, Retail, Multi-Family, Mini-Storage, Mobile Home Park and Marina Boat Slips; property sub-type including Office sub-types, Courtyard, Mid-Rise, and High-Rise, Retail sub-types, Mall, Neighborhood, Strip, and stand-alone; property class, geographic location, investment risk, age and Last year of Major Rehabilitation;
(b) score the property using min, max, and average duration remaining on existing leases, lease rate per square foot in existing leases, historical tenant turnover, and distribution of square footage among existing leases;
(c) score the market of the property's profile by lease rate per square foot, historical length of lease, demographics of residences, traffic counts and lease space absorption rates;
(d) score the local economics of the property by tenant credit ratings, economic health of industries in which tenants conduct business, number of building permits in the approval process in the local economy for similar properties, economic health of geographic location for the property, and crime statistics for the geographic location for the property;
(e) score the existing owners of a property profile by credit rating, designated cash operating expenses;
(f) score the property's price per square foot compared to a property profile;
(g) score the property's ability to service debt compared to a property profile;
(h) score the downtime between leases compared to a property profile;
(i) score the expected change in Value by Valuation Year compared to a property profile; and
(j) score a property's investment risk on a numerical scale ranging from passive to entrepreneurial;
whereby the system displays the property's investment risk score on a numerical scale ranging from passive to entrepreneurial assisting the user in identifying the target buyer and lender without having to search, obtain, and understand third party market data.

11. The computer-implemented web based system for optimizing return on investment in real property according to claim 10, wherein said marketing phase software module stored within a computer memory and capable of accepting user data input and generating data output visually on display screens, further includes a system to:
(a) allow a user to define criteria in the user's target property profile and the system uses the criteria to search for matching property profiles made public by having been posted for sale and in need of a loan;
(b) when a user includes a target risk score in their target property profile, the system ranks the search results by the difference between the target risk score and the risk score of the posted property with the property with the smallest difference being ranked first; and
(c) said system provides the ability for the posting user (User one) to share access to a valuation with a searching user (User two);
whereby the property search results are limited to the user's target property profile criteria and are ranked by the similarity of property profile risk scores thereby improving the quality of the search results which limits the search time and provides more immediate access to the valuation.

12. The computer-implemented web based system for optimizing return on investment in real property according to claim 1, wherein said negotiation and closing phase software module stored within a computer memory and capable of accepting user data input and generating data output visually on display screens, further includes a system to:
(a) allow a user's negotiation goal to be stated in a specific currency and entered by the user,
(b) actively make changes to the negotiation goal entered by the user as the negotiation proceeds;
(c) allow the other party's opening offer to be entered by the user;
(d) allow the users counter offers to be entered by the user as they are made;
(e) allow the other party's subsequent counter offers to be entered by the user as they are made;
(f) calculate the percentage by which the user would like to reduce the other party's last concession to derive their next concession; and
(g) calculate the projected number of counter offer exchanges required for the user to reach their goal;
whereby each time the other party makes a counter offer and it is entered into the system, the system calculates and displays the counter offer the user should make to reach the user's goal and the projected number of counter offer exchanges required to reach the user's goal.

13. The computer-implemented web based system for optimizing return on investment in real property according to claim 1, wherein said negotiation and closing phase software module stored within a computer memory and capable of accepting user data input and generating data output visually on display screens, further includes a system to:
(a) compare two different valuations for the same property; and
(b) compare a valuation with itself at a different point in time;
whereby the data differences are displayed thereby guiding a user in identify changes made to a copy shared with the other party to a negotiation so the user can better understand the basis for the other party's negotiation position, offers, and counter offers and their impact on value; and guide a new owner as they move forward from closing and model and make decisions and therefore changes to the valuation that reflected the closing price.

14. A method for making a computer-implemented web-based system for optimizing return on investment in real property comprising the steps of:
a) providing a qualifying phase software module stored within a computer memory and capable of accepting user data input and generating data output visually on display screens;
b) providing a valuation phase software module stored within a computer memory and capable of accepting user data input and generating data output visually on display screens;
c) providing a developing and deciding on alternatives phase software module stored within a computer memory and capable of accepting user data input and generating data output visually on display screens;
d) providing a marketing phase software module stored within a computer memory and capable of accepting user data input and generating data output visually on display screens;
e) providing a negotiation and closing phase software module stored within a computer memory and capable of accepting user data input and generating data output visually on display screens; and
f) providing a post-closing phase software module stored within a computer memory and capable of accepting user data input and generating data output visually on display screens;
whereby the method guides the user in ordering and executing the calculations within each of the six major phase modules by employing a unified decision support system that provides those transacting business in the real estate market a means of optimizing their return on investment by reducing transaction cost, time, uncertainty, and risk.

15. The method for making a computer-implemented web based system for optimizing return on investment in real property according to claim 14, wherein providing said qualifying phase software module stored within a computer memory and capable of accepting user data input and generating data output visually on display screens further includes a the steps of:
(a) deriving the Weighted Average Net Effective Rental Rate that produces the user's target value using the Income Approach to Value; and
(b) deriving a range of property values that include the user's target value by varying the amount of the capitalization rate and rental rate while holding the amounts for the remaining elements of the Income Approach to Value constant;
whereby the method generates a matrix of property values using the income Approach to Value by varying the rental rate and the capitalization rate to guide the user in deriving the property's current value and the user's target value for comparison with the property's market value to determine the feasibility/advisability of moving forward with the next phase, namely, the valuation phase.

16. The method for making a computer-implemented web based system for optimizing return on investment in real property according to claim 15, wherein providing said qualifying phase software module stored within a computer memory and capable of accepting user data input and generating data output visually on display screens further includes the steps of:
(a) deriving the occupancy cost and ranked amenities for a specific lease by deriving Net Effective Rent for the period of the lease and the average Yearly Net Effective Rental Rate for the period of the lease using Rental Increases that are defined by a period of months rather than lease anniversary dates and are calculated by entering a percentage increase and a new rental rate with other being calculated and displayed, and Rent Abatement by a percent of specific months rather than beginning abatement periods on lease anniversary dates and calculating abatement in whole months;
(b) calculating Total Net Effective Occupancy Cost for the Lease and the Net Present Value of the Net Effective Occupancy Cost for the lease period using Parking by type and cost per type for year one of the lease and then escalating year one over the period of the lease by a user entered percentage, and Tenant Improvement and Miscellaneous costs escalated over the period of the lease by a user entered percentage; and
(c) deriving an amenity score by multiplying user entered number reflecting the importance of that amenity by a user entered number rating the quality of the amenity;
whereby the method displays the results of the calculations described in (a), (b), and (c) above for comparison with but not limited to the user's target lease requirements,
the terms associated with competitive space that is being marketed for lease, and the property's Releasing Assumptions.

17. The method for making a computer-implemented web based system for optimizing return on investment in real property according to claim 14, wherein providing said valuation phase software module stored within a computer memory and capable of accepting user data input and generating data output visually on display screens further includes the steps of:
(a) deriving tenant reimbursed expense amounts;
(b) deriving the amount of the increase in property taxes to be paid by a new owner when specific leases put the burden of such increases on the owner;
(c) deriving the amount for a property expense type when the owner has agreed to pay for that property expense type in the tenant's lease; and
(d) generating audit reports;
whereby the method using user audited occupancy income and expense data calculates the Net Operating Income for the Property thereby increasing the user's confidence and understanding of the accuracy of the calculations and how the property value is determined using the income approach to value.

18. The method for making a computer-implemented web based system for optimizing return on investment in real property according to claim 17, wherein providing said valuation phase software module stored within a computer memory and capable of accepting user data input and generating data output visually on display screens further includes the steps of:
(a) deriving the structure of the target financing by deriving the type, amount, interest rate, and term of the first loan, debt service, and debt coverage ratio: deriving the type, amount, interest rate, loan term and annual debt service of a second loan; and deriving the down payment, total loan to value ratio, total debt coverage ratio, cash flow by valuation year and cash on cash return by valuation year;
whereby the method derives the terms of the financing for comparison with the terms available in the lending market to guide the user in developing the target financing.

19. The method for making a computer-implemented web based system for optimizing return on investment in real property according to claim 14, wherein providing said valuation phase software module stored within a computer memory and capable of accepting user data input and generating data output visually on display screens further includes the steps of:
(a) calculating by Valuation Year the property's Net Operating Income, Value, Value per Square Foot, Cash Flow, and Cash on Cash Return; and
(b) providing a dash board wherein a user can change the Offering Sale Price and Credit Loss Percentage and navigate from the dash board by way of links directly to Sale Capitalization Rate, Financing, Releasing Assumptions ordered by the Percentage of the property's square footage they address/cover, Other Income, and the Going Out Capitalization Rate;
whereby the method displays a Valuation Summary by Valuation Year and the factors that affect value in the order they affect value—Specifically the Sale Capitalization Rate, Financing, Releasing Assumptions ordered by the Percentage of the property's square footage they address/cover, Other Income, and the Going Out Capitalization Rate to guide the user in selecting the factors to adjust and the amount to adjust them by in order to maximize the measures of return on investment set forth in (a).

20. The method for making a computer-implemented web based system for optimizing return on investment in real property according to claim 14, wherein providing said valuation phase software module stored within a computer memory and capable of accepting user data input and generating data output visually on display screens further includes the steps of:
(a) using discounted cash flows and Internal Rate of Return to value a property and includes deriving Pre-Tax Cash Flows by Valuation Year by employing data for Operating Cash Flow, Tenant Improvements, Leasing Commissions, Furniture, Fixtures & Equipment, Capital Reserves, The Amount Lump Sum Planned Capital Improvements, Pre-Tax Cash Flows, Pre-Tax Cash on Cash Returns, and Net Proceeds from Sale at the end of the valuation period;
(b) providing a dash board wherein a user can change the amount and Valuation Year for Lump Sum Capital Improvements;
(c) deriving a range of property values using discounted cash flows to value the property wherein the range of property values is calculated using a range of incremented Internal Rates of Return; and
(d) providing a dash board wherein a user can change the Offering Sale Price and the system calculates the Offering Capitalization Rate, Leveraged Internal Rate of Return (IRR), and the Unleveraged Internal Rate of Return;
whereby the method displays a dash board including the measures of value set forth in (a) and a matrix of values showing by Internal Rate of Return the values for Price per Square Foot, Sale Price, Capitalization Rate, First Loan to Value Ratio, and Cash on Cash Return to guide the user in selecting and modifying the amounts for the measures set forth in (a) that will be discounted to arrive at the range of Internal Rates of Return displayed in the matrix which further guides the user in deciding on an Offering Sale Price with is associated Price per Square Foot, Capitalization Rate, First Loan To Value Ratio, and Cash on Cash Return which Offering Sale Price is entered and the system uses to calculate and display the Offering Capitalization Rate, Leveraged Internal Rate of Return and the Unleveraged Internal Rate of Return.

21. The method for making a computer-implemented web based system for optimizing return on investment in real property according to claim 14, wherein providing said developing and deciding on alternatives phase software module stored within a computer memory and capable of accepting user data input and generating data output visually on display screens, further includes the steps of:
(a) deriving a pro form a using the income approach to value that includes debt service, loan to value ratio, debt coverage ratio, Operating Cash Flow, Equity, Operating Cash on Cash Returns, Capitalization Rate, Selling Price, and Price per Square Foot for a property whose occupancy income and expenses have been improved as the result of physical improvements so the results of the improvements can be compared with the property's current financial performance measured using the same criteria; and
(b) using the Income Approach to Value including financing and increases in rent, other income, property taxes and other expenses to derive the financial performance of a target property over a projected holding period for comparison with financial performance of the property to be traded where the system calculates the projected changes in Operating Cash Flow, Market Value and Equity for the target property's projected holding period if it is acquired pursuant to a Section 1031 Tax Deferred Exchange;
whereby the method displays the comparisons to guide the user in maximizing their return on investment when deciding to improve a property and trade a property.

22. The method for making a computer-implemented web based system for optimizing return on investment in real property according to claim 14, wherein providing said post-closing phase software module stored within a computer memory and capable of accepting user data input and generating data output visually on display screens, further includes the steps of:
(a) deriving a comparison of the cost and income associated with renewing a tenant whose lease is expiring versus replacing such a tenant, where the system derives the cost of replacing a tenant and renewing a tenant using:
(i) the downtime in months for replacing and renewing a tenant;
(ii) the rentable square feet in the space with the expiring lease;
(iii) the rent per square foot to be charged to a new tenant and a renewing tenant;
(iv) the Tenant Improvement Cost to be incurred for a replacement tenant and a renewing tenant;
(v) the cost for leasing commissions for a replacement tenant and a renewing tenant; and
(vi) the discount rate to be used to derive the net present value associated with replacing a tenant and the net present value associated with renewing a tenant;
whereby the method displays the cost, income and net present value of replacing and renewing a tenant thereby guiding the user in their decision making process as leases are about to expire.

23. The method for making a computer-implemented web based system for optimizing return on investment in real property according to claim 14, wherein providing said marketing phase software module stored within a computer memory and capable of accepting user data input and generating data output visually on display screens, further includes the steps of:
(a) defining properties that are similar according to a property profile employing data on property type including Office, Research and Development, Industrial, Warehouse, Flex, Retail, Multi-Family, Mini-Storage, Mobile Home Park and Marina Boat Slips; property sub-type including Office sub-types, Courtyard, Mid-Rise, and High-Rise, Retail sub-types, Mall, Neighborhood, Strip, and stand-alone; property class, geographic location, investment risk, age and Last year of Major Rehabilitation:
(b) scoring the property using min, max, and average duration remaining on existing leases, lease rate per square foot in existing leases, historical tenant turnover, and distribution of square footage among existing leases;
(c) scoring the market of the property's profile by lease rate per square foot, historical length of lease, demographics of residences, traffic counts and lease space absorption rates;
(d) scoring the local economics of the property by tenant credit ratings, economic health of industries in which tenants conduct business, number of building permits in the approval process in the local economy for similar properties, economic health of geographic location for the property, and crime statistics for the geographic location for the property;
(e) scoring the existing owners of a property profile by credit rating, designated cash operating expenses;
(f) scoring the property's price per square foot compared to a property profile;
(g) scoring the property's ability to service debt compared to a property profile;
(h) scoring the downtime between leases compared to a property profile;
(i) scoring the expected change in Value by Valuation Year compared to a property profile; and
(j) scoring a property's investment risk on a numerical scale ranging from passive to entrepreneurial;
whereby the method displays the property's investment risk score on a numerical scale ranging from passive to entrepreneurial assisting the user in identifying the target buyer and lender without having to search, obtain, and understand third party market data.

24. The method for making a computer-implemented web based system for optimizing return on investment in real property according to claim 23, wherein providing said marketing phase software module stored within a computer memory and capable of accepting user data input and generating data output visually on display screens, further includes the steps of:
(a) allowing a user to define criteria in the user's target property profile and the system uses the criteria to search for matching property profiles made public by having been posted for sale and in need of a loan;
(b) further when a user includes a target risk score in their target property profile, the system ranks the search results by the difference between the target risk score and the risk score of the posted property with the property with the smallest difference being ranked first; and
(c) said system provides the ability for the posting user (User one) to share access to a valuation with a searching user (User two);
whereby the property search results are limited to the user's target property profile criteria and are ranked by the similarity of property profile risk scores thereby improving the quality of the search results which limits the search time and provides more immediate access to the valuation.

25. The method for making a computer-implemented web based system for optimizing return on investment in real property according to claim 14, wherein providing said negotiation and closing phase software module stored within a computer memory and capable of accepting user data input and generating data output visually on display screens, further includes the steps of:
(a) allowing a user's negotiation goal to be stated in a specific currency and entered by the user;
(b) actively making changes to the negotiation goal entered by the user as the negotiation proceeds;
(c) allowing the other party's opening offer to be entered by the user;
(d) allowing the user's counter offers to be entered by the user as they are made;
(e) allowing the other party's subsequent counter offers to be entered by the user as they are made;
(f) calculating the percentage by which the user would like to reduce the other party's last concession to derive their next concession; and
(g) calculating the projected number of counter offer exchanges required for the user to reach their goal;
whereby each time the other party makes a counter offer and it is entered into the system, the system calculates and displays the counter offer the user should make to reach the user's goal and the projected number of counter offer exchanges required to reach the user's goal.

26. The method for making a computer-implemented web based system for optimizing return on investment in real property according to claim 14, wherein providing said negotiation and closing phase software module stored within a computer memory and capable of accepting user data input and generating data output visually on display screens, further includes the steps of:
(a) comparing two different valuations for the same property; and
(b) comparing a valuation with itself at a different point in time;
whereby the data differences are displayed thereby guiding a user in identify changes made to a copy shared with the other party to a negotiation so the user can better understand the basis for the other party's negotiation position, offers, and counter offers and their impact on value; and guide a new owner as they move forward from closing and model and make decisions and therefore changes to the valuation that reflected the closing price.
